(19) United States
(12) Patent Application Publication
(10) Pub. No.: US 2026/0218678 A1
(43) Pub. Date: Jul. 30, 2026

(54) Ring-based Vertical-Axis Wind Turbine (VAWT) System

(71) Applicant: University of Virginia Patent Foundation, Charlottesville, VA (US)

(72) Inventor: Eric Loth, Charlottesville, VA (US)

(73) Assignee: University of Virginia Patent Foundation, Charlottesville, VA (US)

(21) Appl. No.: 19/465,055

(22) Filed: Jan. 30, 2026

Related U.S. Application Data
(60) Provisional application No. 63/751,718, filed on Jan. 30, 2025.

(51) Int. Cl. F03D 3/00; F03D 7/06; F03D 9/25; F03D 13/25

(52) U.S. Cl. CPC F03D 3/005; F03D 7/06; F03D 9/25; F03D 13/256; F05B 2220/706; F05B 2240/93; F05B 2240/95

(57) ABSTRACT

To provide high stability at low cost, a ring-based floatation system for a floating vertical-axis wind turbine is proposed. The system uses a buoyancy torus with a finite shell thickness, which can be sealed to prevent water from leaking inside the torus. This torus shape has an outside and inside diameter on a horizontal plane while having a circular cross-section in a vertical plane. This buoyancy torus serves as a floatation tube to provide buoyancy at a large maximum radial extent to enhance platform stability in terms of both inertia and metacentric height. The torus shape (or a similar faceted shape made of several cylindrical tubes connected in a circle) also provides high radial asymmetry and high structural robustness. This buoyancy torus supports rotating wind turbine blades which are affixed to a rotation ring, where the torus and the rotation ring have the same axis of revolution and where the blades and the rotation ring rotate about this axis of revolution. One or more electrical generators can be placed between the rotation ring and the buoyancy torus (or a foundation for an onshore wind turbine) to convert the rotational power of the blades (communicated to the rotation ring) into electrical power. This ring-based buoyancy platform can be ballasted by a variety of methods and can also be used to support offshore oil and gas drilling platforms.

### CROSS-REFERENCE TO RELATED APPLICATIONS

The present application claims priority from U.S. Provisional Application Ser. No. 63/751,718 filed Ring-floating Vertical-axis Wind Turbine (VAWT) and Related Methods Thereof, entitled “Jan. 30, 2025;” the disclosure of which is hereby incorporated by reference herein in its entirety.

The present application is related to International Application No. PCT/US2024/044594, filed Aug. 30, 2024, entitled “Ring-based Floating and Fixed-Floating Wind Turbine Platforms,” which claims benefit of priority under 35 U.S. C §119(e) from U.S. Provisional Application Ser. No. 63/562,939, filed Mar. 8, 2024, 2018, entitled “Ring-Based Floating and Fixed-Floating Wind Turbine Platforms”; the disclosures of which are hereby incorporated by reference herein in their entirety.

### TECHNICAL FIELD

The present application generally relates to ring-based floating wind platforms which can support floating vertical-axis offshore wind turbines as well as offshore oil and gas platforms.

### INTRODUCTION

Offshore installations of wind turbines can be desirable to access wind power generation. Such installations generally can utilize floating wind turbine arrangements, especially when the water depth is large, e.g., more than 60 meters. Floating wind turbine installations include a flotation structure upon which the turbine is mounted and supported for power generation. These floating installations are typically connected thereto with mooring lines and anchoring system. Floating installations must also provide adequate stability for the respective turbine against forces generated by its own rotor and by external forces generated by the wind and waves. However, current floating wind turbines are often too costly for deployment due, at least partially, to high platform costs. In addition, wind turbines are typically Horizontal-Axis Wind Turbines (HAWT), which require that the rotor must be mounted at a large height with a large tower. In addition, HAWT systems typically require that the generator be mounted at the rotor hub height within a nacelle, along with the yaw system. This can result in large maintenance costs for these systems more expensive. On the other hand, Vertical-Axis Wind Turbines (VAWT) can allow the generator to be located at a lower height, which can allow more direct access. This also allows the center of the gravity of the turbine to be lower, which can improve stability. However, VAWT systems tend to operate at lower rotation rates combined with higher torques compared to HAWT systems at the same power level, which makes the VAWT generator more expensive. Furthermore, VAWT systems tend to have lower aerodynamic efficiencies (compared to HAWT systems) so they require larger swept areas for a given available wind energy, which can increase their cost. Furthermore, VAWT systems tend to have additional cyclic oscillations.

For more widespread deployment of wind turbines in deep water, there is a long felt need for a solution that provides, among other things, a floating VAWT system that is less expensive to build, install, and maintain, and which provides sufficient stability to the wind turbine in the face of gravitational forces and rotor, wind, and wave forces, and uses a ring-based floating system. Such a ring-based floating system may also be helpful for floating offshore oil/gas platforms.

### SUMMARY OF ASPECTS OF EMBODIMENTS OF THE PRESENT INVENTION

To provide high stability at low cost, a ring-based floatation system for a floating vertical-axis wind turbine (VAWT) is proposed. The system uses an outer buoyancy torus with a thin shell, which can be sealed to prevent water from leaking inside the torus. The external shape of the buoyancy torus is a ring torus shape or is nearly a ring torus shape. For example, the buoyancy torus can be composed of a series of several cylindrical sections to provide a nearly ring torus shape. In this way, the buoyancy torus can be assembled using the same manufacturing and assembly process used for offshore wind turbine towers. In particular, offshore wind turbine towers are often composed of several cylinder shells (cans) that are about three meters long and are welded together into sections, and then multiple sections are bolted together to form the entire tower. For the buoyancy torus described herein, a similar process can be used. For example, eight sections representing 45° arcs in a horizontal plane can be individually sealed and then the sections are bolted together to form a 360° ring torus. For a buoyancy torus with an external diameter of 99 meters, each 45° section can be composed of thirteen straight cylinders that are about 2.99 meters long with a 3.5° angle cut on one side. As a result, the eight sections made of 104 cylinders create a nearly perfect ring torus with 104 facets. In general, the number of cylinders used to form the buoyancy torus can be eight or more.

The buoyancy torus is composed of thin-walled shell to contain air inside and is water-tight and semi-submerged to provide buoyancy as a floating wind turbine platform. As such, this buoyancy torus serves as a floatation tube to provide buoyancy at a large maximum radial extent (from the axis of revolution) to enhance platform stability in terms of both inertia and metacentric height. The buoyancy torus shape also provides high radial asymmetry and high structural robustness.

This buoyancy torus can support rotating wind turbine blades (referred to hereafter as “blades”) which are affixed to a rotation ring. The rotation ring carries the torque of the wind turbine blade and so the rotation ring must be structurally robust, e.g., may have the shape of a hoop or the shape of a ring torus. This rotation ring rotates with the blades and is supported vertically by the buoyancy torus, which does not rotate with the blades since it is moored. The rotation ring can rotate with respect to the buoyancy torus using wheels and/or a bearing system on one or more circular rails. One or more electrical generators can be placed between the rotation ring and the buoyancy torus to convert the rotational power of the blades (communicated to the rotation ring) into electrical power.

This design improvement for this concept can reduce the overall mass and cost of a floating wind turbine as compared to conventional horizontal-axis floating wind turbine designs in several ways. First, it eliminates the wind turbine tower and allows the power generation components to be closer to water level. Second, the proposed VAWT system also does not require a yaw-based system since the wind can arrive from any horizontal direction without a reduction in performance. Third, the rotation ring (which replaces the hub and shaft of a conventional horizontal-axis wind turbine) serves as high diameter rotating driver for an electrical generator, which can be used for a friction drive system (which eliminates the complex and heavy gearbox used for a conventional geared wind turbine transmission system) or for a direct-drive system (which reduces the magnetic loading and/or current density compared to a conventional shaft-based direct-drive wind turbine system).

This ring-based buoyancy platform can be ballasted by a variety of methods and can also be used to support offshore oil and gas drilling platforms. The platforms may also be used for other operations or industries other than oil and gas.

The invention itself, together with further objects and attendant advantages, will best be understood by reference to the following detailed description, taken in conjunction with the accompanying drawings.

These and other objects, along with advantages and features of various aspects of embodiments of the invention disclosed herein, will be made more apparent from the description, drawings and claims that follow.

An aspect of an embodiment of the present invention provides, among other things, a ring-based Vertical-Axis Wind Turbine (VAWT) system. In an embodiment, the system may comprise: a circular rotor, wherein said circular rotor comprises a rotation ring and two or more rotor blades attached thereto; wherein said rotation ring is configured to encircle and rotate about a vertical axis or nearly-vertical axis; wherein said attached rotor blades extend vertically upwards from said rotation ring, and optionally, are configured to be in a radially outward angle as they extend upwards to increases the swept area at higher elevations, wherein in said radially outward angle defines a radially-outward blade tilt angle; and wherein said rotor blades are configured to be driven aerodynamically by the wind so that said rotor blades and said rotation ring can rotate about the same axis of rotation, which is the vertical axis of rotation or nearly-vertical axis of rotation, to provide mechanical rotational power from the wind.

An aspect of an embodiment of the present invention provides, among other things, the VAWT system that is configured to operate as a floating offshore VAWT system. In an embodiment, the system may further comprise: a buoyancy torus that is configured to be non-rotating; wherein said buoyancy torus has an axis that is the same axis as said axis of rotation of said rotation ring and is configured to vertically support said circular rotor; and wherein said buoyancy torus is configured to support one or more electrical generators that are configured to extract rotational mechanical power from said circular rotor.

An aspect of an embodiment of the present invention provides, among other things, the VAWT system that is configured to operate as an onshore VAWT system. In an embodiment, the system may further comprise: a foundation; wherein said foundation is configured to vertically support said rotation ring; wherein said foundation does not rotate during power generation; and wherein said foundation supports said one or more generators that are configured to extract the rotational mechanical power from said circular rotor.

An aspect of an embodiment of the present invention provides, among other things, the ability to provide high stability at low cost, a ring-based floatation system for a floating vertical-axis wind turbine is proposed. In an embodiment, the system uses a buoyancy torus with a finite shell thickness, and can be a perfect ring torus or composed of eight or more cylindrical thin-walled segments joined together. This torus shape has an outside and inside diameter on a horizontal plane while having circular cross-sections in a vertical plane. This buoyancy torus which can be sealed in sections or as a single unit to prevent water from leaking inside the buoyancy torus so it serves as a floatation tube to provide buoyancy at a large maximum radial extent to enhance platform stability in terms of both inertia and metacentric height. The torus shape (or a similar faceted shape made of several cylindrical tubes connected in a circle) also provides high radial asymmetry and high structural robustness. This buoyancy torus supports rotating wind turbine blades which are affixed to a rotation ring, where the torus and the rotation ring have the same axis of revolution and where the blades and the rotation ring rotate about this axis of revolution. One or more electrical generators can be placed between the rotation ring and the buoyancy torus (or a foundation for an onshore wind turbine) to convert the rotational power of the blades (communicated to the rotation ring) into electrical power. This ring-based buoyancy platform can be ballasted by a variety of methods and can also be used to support offshore oil and gas drilling platforms.

Additional descriptions of aspects of the present disclosure will now be provided with reference to the accompanying drawings. The drawings form a part hereof and show, by way of illustration, specific embodiments or examples.

### BRIEF DESCRIPTION OF THE DRAWINGS

The foregoing and other objects, features and advantages of the present invention, as well as the invention itself, will be more fully understood from the following description of preferred embodiments, when read together with the accompanying drawings

The accompanying drawings, which are incorporated into and form a part of the instant specification, illustrate several aspects and embodiments of the present invention and, together with the description herein, serve to explain the principles of the invention. The drawings are provided only for the purpose of illustrating select embodiments of the invention and are not to be construed as limiting the invention.

FIGS. 1A-B is a schematic side view (FIG. 1A) and top view (FIG. 1B) of a ring-based floating vertical-axis wind turbine (VAWT) in an exemplary embodiment showing a cross-section of a buoyancy torus (which is partially submerged) and a rotation ring 7 (which is not submerged), where the buoyancy torus is connected by a rotational support system.

FIG. 2 is a schematic side view of a ring-based floating vertical-axis wind turbine (VAWT) as in FIG. 1A in operation based on a wind that is blowing left-to-right showing the primary forces (with directions indicated by arrows) acting on the rotating blades, blade cables (showing an example of one cable per blade attached to the opposite point on the rotation ring), and blade spacer during operational conditions where the blade rotation about the vertical axis of rotation create torque and power as well as a downwind thrust force (to the right) and tension forces of the spacer and blade cables are illustrated.

FIGS. 3A-B is a schematic side view (FIG. 3A) and top view (FIG. 3B) of a ring-based floating vertical-axis wind turbine (VAWT) at a time when the blades are now at front and back positions, showing that the chord of a blade may decrease at higher elevations and showing the example of two blade cables per blade, where the cables are attached at a single blade elevation but at two different points on the rotation ring as in FIG. 1B.

FIGS. 4A-B is a schematic side view (FIG. 4A) as in FIG. 1A and a bottom view (FIG. 4B) to show four mooring lines, which prevent the buoyancy torus from rotating during power generation.

FIGS. 5A-B are schematic top views of a ring-based floating vertical-axis wind turbine (VAWT) with two different embodiments where FIG. 5A shows three blades and three blade spacers, so the spacers form a triangle (as seen from above) and where there is one blade cable per blade that attaches at the opposite side of the rotation ring, while FIG. 5B shows a different option with four blades and two blade spacers, which form a cross (as seen from above) and where there is two blade cables per blade where the cables attach at one location on the blade but at two different points of the rotation ring.

FIG. 6 is a schematic side view of a ring-based floating vertical-axis wind turbine (VAWT) as in FIG. 2 but now including tip cables to provide additional structural support to blades to resist radially outward forces near the blade tips.

FIG. 7 is a schematic side view (FIG. 7A) and top view (FIG. 7B) (without blade cables shown) of a ring-based floating vertical-axis wind turbine (VAWT) as in FIG. 1 showing four electrical generators attached to the buoyancy torus and driven by the inside of the rotation ring using a friction-drive system.

FIG. 8 is a schematic side view of two circular rotation rails attached to the rotation ring, while the torus wheels 6 and respective axle are situated below the rotation rails and the axle is supported on the buoyancy torus connected by a support. The gravitational downward force of the rail on the wheels can be used to minimize slippage and the rotation of one or more wheel axles can be used as one or more shafts to drive one or more electrical generators.

FIG. 9 is a schematic enlarged top partial view of a single blade (without blade cables or blade spacers being shown) with a system that allows allowing for variable pitch angle of the blade, where this angle can be adjusted as the blade rotates about the vertical axis of rotation with an Independent Pitch Control system.

FIG. 10 is a schematic side view of a ring-based floating vertical-axis wind turbine (VAWT) as in FIG. 3 but with an airfoil horizontal cross-section part of the blade for the upper most portion of the blade and a circular horizontal cross-section at a lower portion (which is the wave region where waves may impact the blade) and an intermediate transition section whose horizontal cross section transitions from a circle to an airfoil at increasing elevations.

FIGS. 11A-B is a schematic side view (FIG. 11A) and top view (FIG. 11B) as in FIG. 3 but now showing the blades with a forward blade sweep angle at higher elevations (into the direction of rotation).

FIG. 12 is a schematic side view of a ring-based floating vertical-axis wind turbine (VAWT) as in FIG. 10 but without a blade intermediate transition section and with now including a forward blade arrangement as in FIG. 11A.

FIGS. 13A-C schematically show aerodynamic fairings configured to reduce drag, where the fixed fairing 43 (as shown in FIG. 13A) is fixed to a blade spacer; the fixed fairing (as shown in FIG. 13B) is fixed around a blade cable, and the free fairing (as shown in FIG. 13C) is freely supported around a blade cable and includes a flat tail so that the free fairing self-aligns aerodynamically with the oncoming wind to minimize drag.

FIGS. 14A-B is a schematic side view (FIG. 14A) and bottom view (FIG. 14B) (from underwater) of a ring-based floating vertical-axis wind turbine (VAWT) similar to FIG. 4 (without showing the mooring lines) but with the addition of an underwater circular ballast ring that is connected to the buoyancy torus with vertical ballast cables, which allows the underwater ballast ring to sway as in a pendulum with respect to the buoyancy torus.

FIGS. 15A-B is a schematic side view (FIG. 15A) and bottom view (FIG. 15B) (from underwater) of a ring-based floating vertical-axis wind turbine (VAWT) as similar to FIGS. 14A-B, respectively, but with the addition of underwater cross ballast cables 67 which may be pre-tensioned so that the underwater ballast ring 61 is rigidly attached to the buoyancy torus 4, so it does not sway with respect to the buoyancy torus.

FIGS. 16A-B is a schematic side view (FIG. 16A) and bottom view (FIG. 16B) (from underwater) of a ring-based floating vertical-axis wind turbine (VAWT) similar to FIGS. 14A-B, respectively, but with a center underwater ballast 70 that is connected to the buoyancy torus 4 with underwater angled ballast cables.

FIG. 17 is a schematic side view of a ring-based floating vertical-axis wind turbine (VAWT) 1 similar to FIG. 16A showing the rotation ring at an angle to the horizon, where the underwater angled ballast cables are fixed to the underwater center ballast so the ballast can sway so that the underwater angled ballast cables can stay be in tension (to avoid snap loads on the underwater angled ballast cables).

FIGS. 18A-B is a schematic side view (FIG. 18A) and a bottom view (FIG. 18B) (from underwater) of an oil/gas offshore platform which is elevated above the wave zone or region and is supported vertically by outer columns and a central column, where the outer columns rest on the buoyancy torus, which provides buoyancy support, where the central column is partially submerged and sealed to provide additional buoyancy support, where buoyancy torus cables can connect the buoyancy torus to the bottom of the central column to provide additional structural support, and where mooring lines serve to help anchor the platform.

FIG. 19 is a schematic side view of an oil/gas offshore platform similar to FIG. 18A, but with the additional of an underwater circular ballast ring (similar to FIG. 14A) and underwater vertical ballast cables (similar to FIG. 14A) to provide additional stability.

FIG. 20 is a schematic side view of an oil/gas offshore platform similar to FIG. 18A, but with underwater central column (of FIG. 18A) replaced by a monopile (so mooring lines are no longer needed) and the monopile is connected to the buoyancy torus with underwater angled buoyancy cables, and where the buoyancy torus is now fully submerged.

FIGS. 21A-B schematically showing a top view cross sections of a blade at three different elevations (where blade cables and blade spacers are not shown) for a system with no pitch control so the blade chord is always tangent to a circle about a vertical axis of rotation (FIG. 21A) vs. a system with variable pitch control (FIG. 21B) for fixed pitch where the blade chord angle at this instance is pitched at ten degrees away from away a circle about a vertical axis of rotation and this angle can generally vary as the blade rotates via an Independent Pitch Control system.

FIG. 22A-B schematically show a side view of the turbine lower portion of the blade with no pitch control (below the point) and an upper portion of the blade 19 (above the point) with adjustable/variable pitch, where, as shown in FIG. 22A, the both portion of the blade have the same a radially outward angle at the point.

FIG. 23 is a schematic side view of a ring-based onshore vertical-axis wind turbine (VAWT) similar to the ring-based floating vertical-axis wind turbine (VAWT) as in FIG. 1A but which is supported by a foundation rather than a buoyance torus.

FIG. 24 is a schematic side view of a portion of ring-based onshore vertical-axis wind turbine (VAWT) similar to the portion of the ring-based floating vertical-axis wind turbine (VAWT) as in FIG. 8 but which is supported by a foundation rather than a buoyance torus.

FIGS. 25A-B is a schematic side view (FIG. 25A) and top view (FIG. 25B) of a ring-based onshore vertical-axis wing turbine (VAWT) similar to the schematic side view (FIG. 1A) and top view (FIG. 1B), respectively, of a ring-based floating vertical-axis wind turbine (VAWT) but which is supported by a foundation rather than a buoyance torus.

FIG. 26 is a schematic side view of a portion of ring-based onshore vertical-axis wind turbine (VAWT) similar to FIG. 24 with a circular rotation ring of the box-beam type and a generator.

FIG. 27 is a schematic side view of a portion of ring-based onshore vertical-axis wind turbine (VAWT) similar to FIG. 24 with a circular rotation ring of the I-beam type and a generator of the Mag-Lev type.

### DETAILED DESCRIPTION OF ASPECTS OF EMBODIMENTS OF THE PRESENT INVENTION

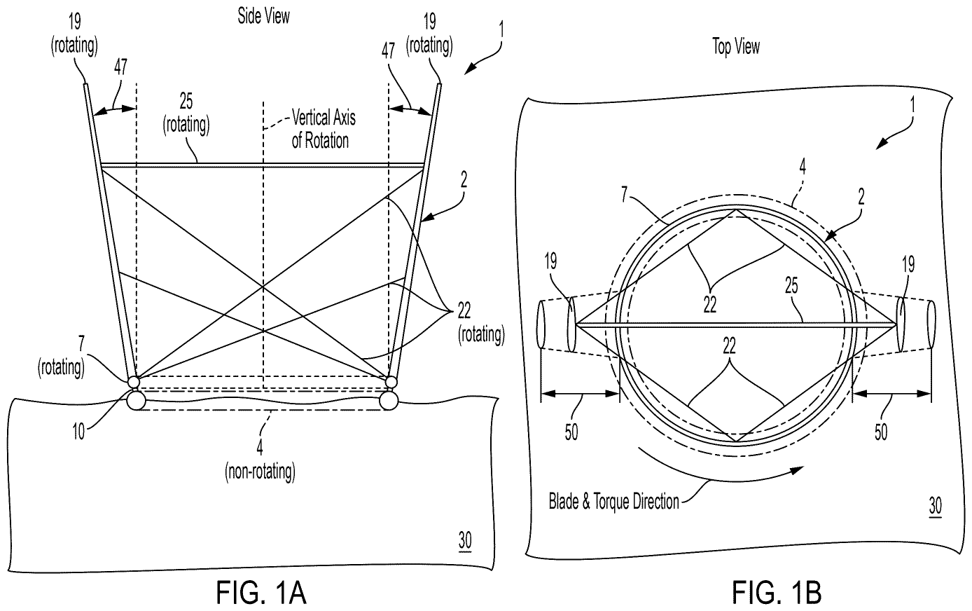

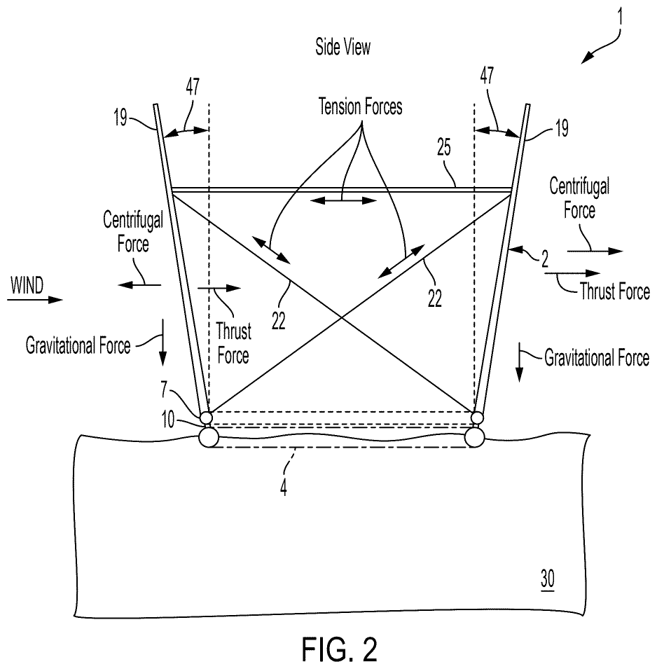

To provide low-cost offshore wind energy, a ring-based floating Vertical-Axis Wind Turbine (VAWT) system 1 is proposed. Once deployed with a wind turbine, the buoyancy torus lies flatwise on the water so that its axis of revolution is vertical or nearly vertical. As such, the torus when viewed from the side in a vertical plane has circular cross-sections as shown in FIG. 1A and when the buoyancy torus is viewed above includes an outside and inside diameter on a horizontal plane where the outside and inside torus edges are circular as shown in FIG. 1B, or the torus edges are nearly circular with facets when the buoyancy torus composed of several cylinders. The buoyancy torus 4 is in the form of thin-walled shell that can seal in air as a ring-based flotation tube as shown in FIGS. 1 and 2 to provide buoyancy at a large maximum radial extent to enhance platform stability in terms of both inertia and metacentric height. The buoyancy torus 4 can also be used to support a surface platform to provide a convenient docking area near the wind turbine tower for water vessels used for installation, maintenance, or decommissioning of the turbine.

As mentioned previously, once deployed with a wind turbine, the buoyancy torus lies flatwise on the water so that its axis of revolution is vertical or nearly vertical. Regarding the offshore version (e.g., floating) with a buoyancy torus downwind thrust forces in high winds can cause a the axis of revolution of the buoyancy torus to tilt toward the downwind direction by a few degrees (e.g., less than 5 degrees) so that the axis of rotation for the rotation ring and the blades also would tilt the same amount. Nearly vertical (e.g., less than 5 degrees) is considered substantially vertical (e.g., less than 5 degrees).

In an embodiment, the ring-based floatation system can directly support a Vertical-Axis Wind Turbine (VAWT) 1 rotor system with two or more aerodynamically-shaped blades 19 that rotate about a vertical axis of rotation at the center of the buoyancy torus 4, as in the example of the two-bladed 19 configuration shown in FIGS. 1 and 2. The base of the wind turbine blades 19 would be connected to a circular rotation ring 7 that rotates with the blades 19. The buoyancy torus 4 and rotation ring 7 surround the same common vertical axis of rotation in still water with no wind.

The various embodiments of the rotation ring 7 may be used with onshore or offshore (e.g., floating) versions of the VAWT 1 and rotor 2. In an embodiment, the rotation ring 7 may be, for example, but not limited thereto, one the following types: a) torus with circular shell, b) box-beam rectangular shell, or c) I-beam. These embodiments may be used for both onshore and offshore versions (e.g., floating) of the VAWT 1 and rotor 12.

The various embodiments of the VAWT 1 and rotor 2 discussed herein may be used for either a ring-based onshore vertical-axis wind turbine (VAWT) 1 or a ring-based floating (e.g., offshore) vertical-axis wind turbine (VAWT) 1.

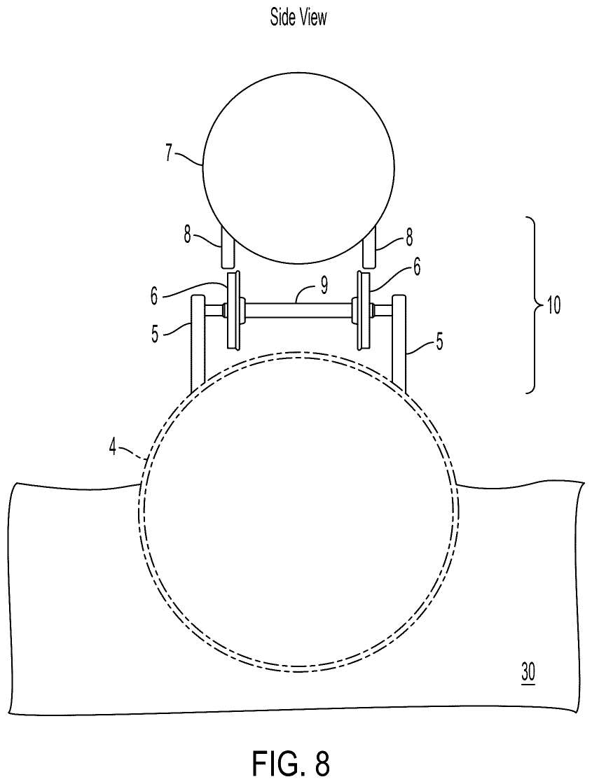

In an embodiment, one or more circular rails 8 (shown in FIG. 8) can be connected to the rotation ring 7 and supported on the non-rotating buoyancy torus 4 using a friction-based drive system 10 that may include steel wheels 6 (shown in FIG. 8). And these wheels can provide high RPM drive to one or more generators. In another embodiment, a large diameter generator rotor can be connected to the rotation ring 7 and a large diameter generator stator can be connected to the buoyancy torus, where the relative rotation of the generator rotor to the generator stator generates electrical energy.

In an embodiment, the rotor 2 of the Vertical-Axis Wind Turbine (VAWT) 1 may include the blade(s) 19 and rotation ring 7. In an embodiment the rotor 2 of the Vertical-Axis Wind Turbine (VAWT) 1 may include the blade(s) 19, rotation ring 7, blade cable(s) 22, blade spacer(s) 25, and tip cable(s) 32.

In an embodiment, some or all of the rotor blades 19 would lean radially outward to increase swept area. The blade span is the distance from the bottom of the blade 19 to the top of the blade 19. The horizontal spacing between opposing blades 19 at a given spanwise location can be held fixed with a blade spacer 25 structural spar and the also supported by blade cables 22 which are attached to the rotation ring 7 as well, as shown in FIGS. 1-3 for a two-bladed system. The cable attachment on a blade at a given elevation (i.e., spanwise location) will generally be at or close to at the center of pressure chordwise location, to minimize chordwise torque on the blade 19. For each blade 19, one or more blade cables 22 attaching at one or more locations on the blade 19 and attaching at one or more locations on the rotation ring 7 can be used. For example, FIG. 1A shows two blade cables 22 per blade 19 which attach above at two different blade spanwise locations and attach below at one rotation ring 7 locations. As another example, FIG. 1B shows two blade cables 22 per blade 19 which attach above at one blade spanwise location and attach below at two different rotation ring 7 locations.

In an embodiment, the rotor blades 19 may have a symmetric aerodynamic shape (airfoil profile) along most or all of their span so they may provide torque (due to an oncoming wind) in a consistent direction when the blades 19 are either upwind or downwind of the turbine center. The blades 19 may be manufactured using similar techniques and materials used for conventional wind turbines, e.g., using mostly fiberglass construction and other fiber-reinforced composites, like carbon-fiber composites. The blades 19 may include one more shear webs and may include one or more spar caps.

In an embodiment, for additional structural efficiency, the blades 19 can have a larger chord near the bottom and a smaller chord near the top, as shown in FIGS. 1-3. This vertical tapering can provide structural efficiency, similar to the benefits of radial tapering used for HAWT blades. In addition, the normalized blade thickness (ratio of maximum thickness to chord length at a particular spanwise station) can have a vertically-upward reduction along the blade 19 for this VAWT concept to provide increased aerodynamic efficiency for higher elevation stations and increased structural efficiency for the lower elevation stations. This is similar to the radially-outward reduction in normalized blade thickness along the blade 19 for HAWT rotors 2, where these reductions can provide increased aerodynamic efficiency for the outboard stations and increased structural efficiency for the inboard stations.

In addition, in an embodiment, some or all of the blades can 19 be positioned to lean outward as they rise vertically from the rotation ring. For example, FIGS. 1-3 show the entire blade leaning with a single radially-outward tilt angle 47 yielding an outward tilt distance 50 at the blade tip. There are two main benefits for this radially-outward blade tilt 47 (as compared to blades which are vertical but with no outward tilt). First, this radially-outward tilt 47 increases the swept area of the VAWT 1 system (as reflected by the outward tilt distance 50) for a given blade height and a given rotation ring 7 diameter (as compared to that for vertical blades). Such an increase in swept area at higher elevations is also beneficial since the wind speeds are generally higher at higher elevations. Secondly, this radially-outward tilt 47 will result in gravitational forces that cause a radially-outward moment on the blade, which can ensure that the blade supporting structural members (e.g., cables and spacer bar) are in tension when the blades are not spinning. Having such members in tension can increase structural efficiency since structural members tends to be lighter when they primarily support tensile forces, so that the blade 19 supporting structural members can have lower mass and therefore lower cost.

In an embodiment, the outward radially blade tilt 47 can be designed so that tension is generally maintained for the blade supporting structural members even in operational conditions, since rotor spinning will cause additional outward centrifugal forces that can counteract downwind thrust forces, which will vary depending on the blade position relative to the wind. To illustrate this, a qualitative diagram of the centrifugal, gravitational, thrust and structural member forces acting on an upwind blade and a downwind blade is shown in FIG. 2. It can be seen that rotor thrust causes a radially-outward force when the blade 19 is translating along the downwind side of the rotation ring 7 but a radially-inward force when the blade 19 is translating along the upwind side of the ring. To ensure the cable and spacer support systems stay in tension during operation conditions, the net radially-outward moment of the blade 19 can be kept positive by ensuring that the outward moment due to the combination of the gravitational forces and centrifugal forces always exceeds that for the downwind thrust moments. This will be most difficult to achieve when the blade 19 is most upstream (e.g., the blade on the left in FIG. 2) and when the rotor 2 is operating at the rated wind speed conditions, where the blade thrust is maximized. Ensuring a positive radially-outward moment at rated conditions even when the blade 19 is upstream can be accomplished by careful design of spanwise blade mass distribution, spanwise thrust distribution, the radially outward tilt angle 47, the rated blade rotation rate and aeroelastic deflections.

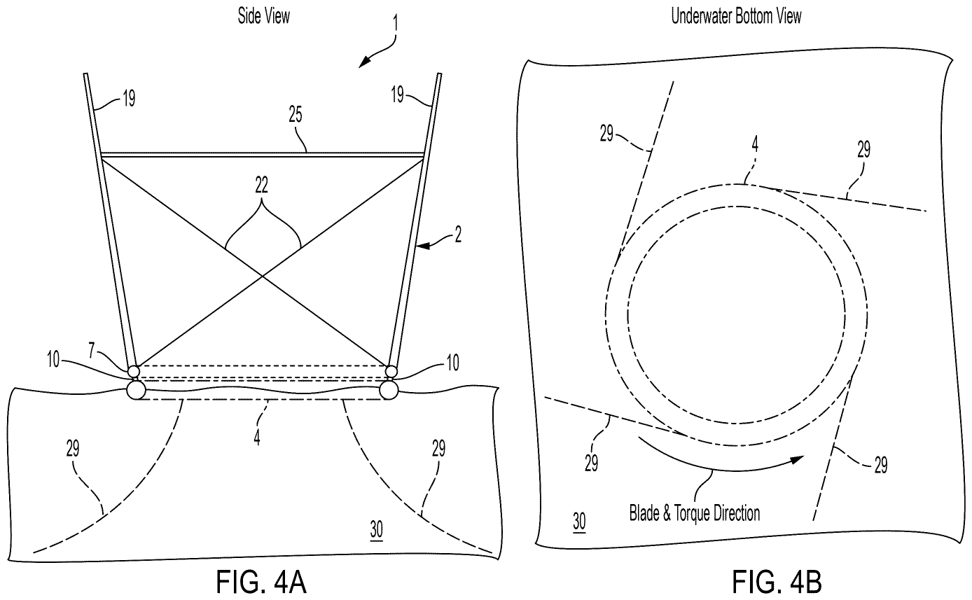

In an embodiment, in order for the buoyancy torus 4 to be non-rotating while the rotor blades 19 are spinning and providing torque, the mooring lines 29 are designed to resist the rotor transmitted torque. This can be accomplished by placing the mooring lines 29 so that they attach with a tangential component relative to the buoyancy torus 4 during operation as shown in FIG. 4 so the mooring line tension can resist this torque.

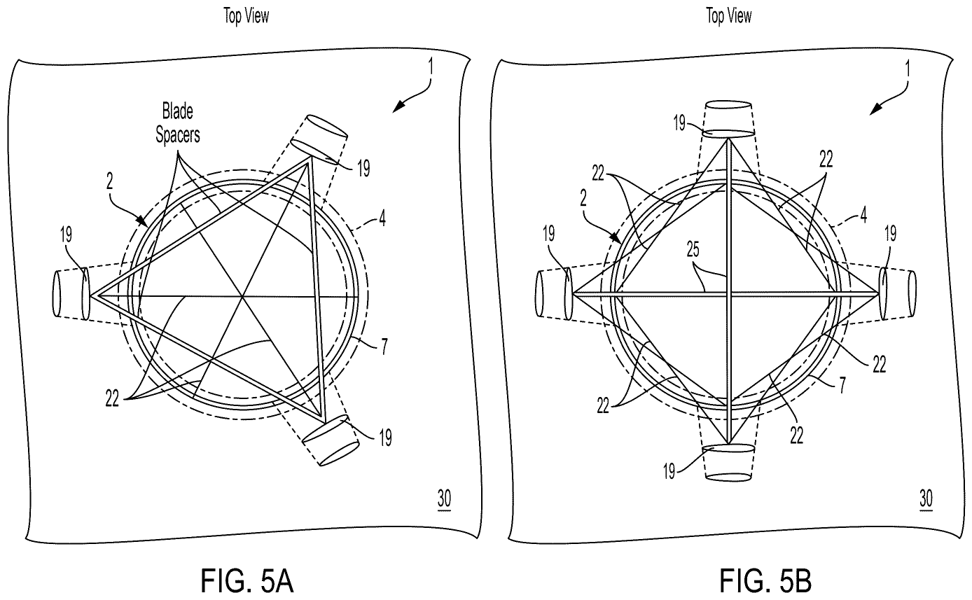

In an embodiment, the number of vertical blades 19 can vary from one to many, e.g., two blades 19 as shown in FIGS. 1-4 or three blades 19 as shown in FIG. 5A or four blades as shown in FIG. 5B. With more blades 19, the blade spacers 25 can be connected to increase rotor 2 rigidity. For example, the blade spacers 25 for three blades 19 can be in the form of a triangle as shown in FIG. 5A or a circle. As another example, the blade spacers 25 for four blades 19 can be in the form of a cross as shown in FIG. 5B. For four blades 19, the blade spacers 25 can be connected as a square. For three or more blades 19 the blade spacers 25 can also be in the form of a ring, i.e. seen as a circle from above. For each blade 19, one or more blade cables 22 attaching at one or more locations on the blade 19 and on the rotation ring 7 can be used. For example, FIG. 5A shows one blade cable 22 for each blade 19 attaching at a single directly-opposing location on the rotation ring 7 while FIG. 5B shows two blade cables 25 for each blade 19 attaching at two locations on the rotation ring 7.

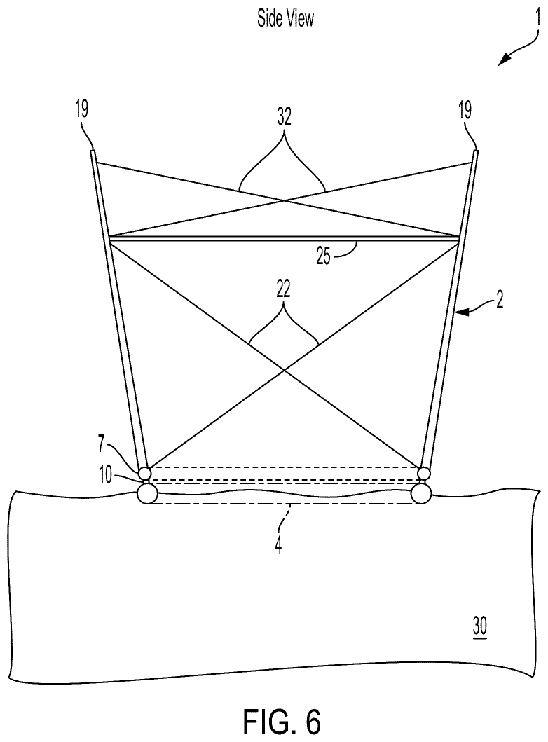

In addition, in an embodiment, higher elevation cables 32 can be added to increase rotor blade rigidity in conjunction with the blade spacer 25. For example, FIG. 6 shows the addition of tip cables 32 to reduce tip deflection. This can be helpful especially since the blade tips of the blades 19 will generally see higher wind speeds with higher local aerodynamic loads and since the blade tips will have smaller chord lengths, which tend to be more flexible. Another approach to increase rotor 2 rigidity is to add one or more trusses to connect the blades 19.

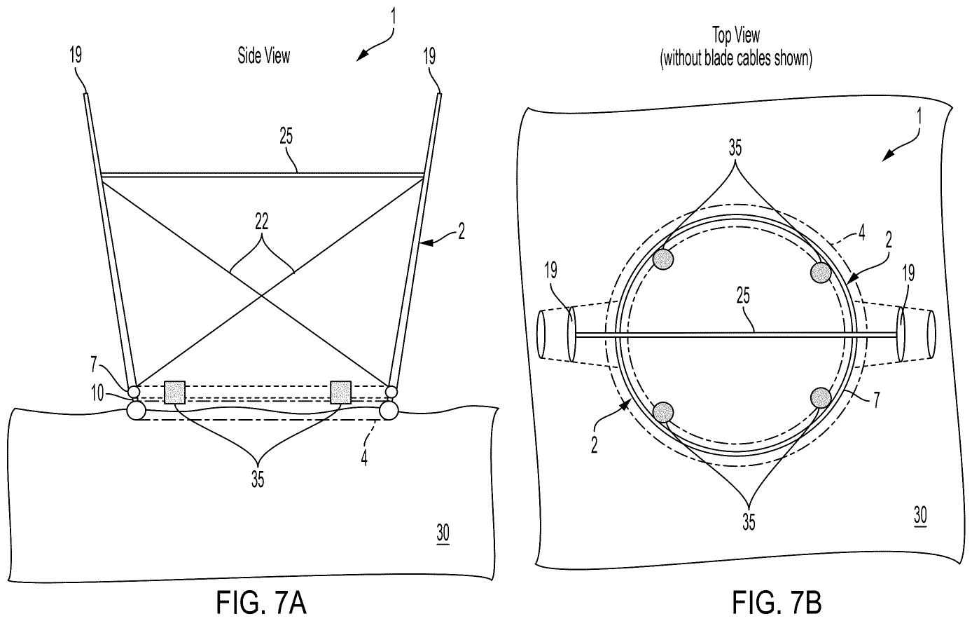

In an embodiment, the system Power Take Off (PTO) which converts the rotational mechanical power into electrical power can be accomplished by mounting one or more electrical generators 35 on the buoyancy torus 4 that are driven by the rotation ring 7 as shown in FIGS. 7A-B, i.e. using a friction-based rim-driven. Using multiple generators 35 may allow for redundancy and allow for generator weight to be more evenly distributed around the buoyancy torus 4. Having multiple generators 35 can allow a turbine 1 to continue to operate even if one of the generators 35 is not working properly by disengaging that generator 35, i.e., taking it offline. Locating the PTO near the buoyancy torus 4 can also improve access for maintenance and repair of the VAWT 1 PTO as compared to a HAWT PTO system that is located at the top of a large tower.

In an embodiment, also using a friction-based rim-driven system for the generator 35 or generators 35 can take advantage of the high circumferential speeds of the rotation ring 7 with a drive system 10 can be used. Such a friction-based drive system is used on large diameter observation/Ferris wheels where pneumatic tires are driven by an electric motor at a high RPM provide circumferential torque to the observation/Ferris wheel which rotates at a low RPM. Since the circumferential speeds for are higher (e.g., circumferential speeds ranging from 30 m/s to 50 m/s) and loads are much greater (e.g., large mass of turbine blades), steel wheels 6 with a rail 8 (as used in trains) using gravitational vertical force to minimize slippage between a rail and a wheel are likely to be more practical for this large wind turbine system 1. The circular rail 8 or rails 8 can be attached to the rotation ring 7, while the steel wheels 6 and axels/shafts 9 are situated below the rails 8 and supported on the buoyancy torus 4 and attached using a wheel support 5, as shown in FIG. 8. (Note that this setup with two rails on top of wheels is an upside-down version of train tracks whereby the train wheels are above the rail). One or more electrical generators 35 can then be attached to one or more of these axles 9 to extract power from the high RPM rotation, where the wheels 6 on such an axle 9 represent driver wheels 6. Such a friction-based drive system can be beneficial compared to a gearbox system that uses a central shaft at the vertical axis of rotation of the rotation ring. This is especially true because a VAWT system tends to have lower tip speed ratios (compared to a HAWT system) which results in even lower rotation speeds, i.e., lower RPMs (compared to a HAWT system). Lower RPMs results in higher torque for a given power, which can make for a very heavy and complex gearbox if located at the vertical axis of rotation of the rotation ring 7.

Another PTO option is to use a direct-drive system where the generator stator is attached to buoyancy torus 4 (and leverages that torus for structural rigidity) and the generator rotor is attached to rotation ring 7 (and leverages that ring for structural rigidity). Such a system can take advantage of the circular rail 8 and steel wheel system 6 described above to ensure a steady gap between the generator rotor and the generator stator.

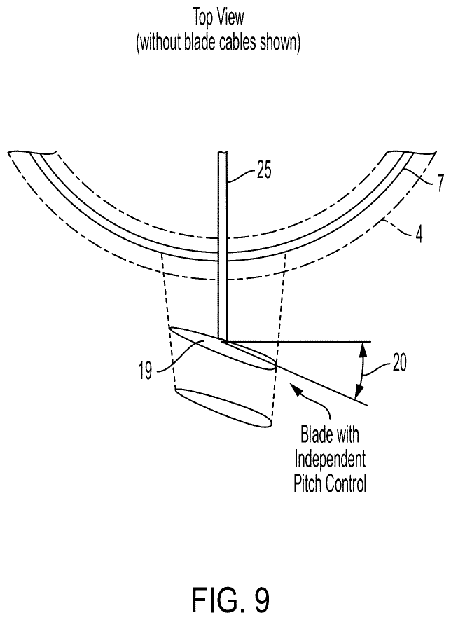

One disadvantage of a VAWT system (vs. a HAWT system) is that the blades will experience large angle of attack variations for each rotation. This can lead to stall angles of attack, which problematically reduce aerodynamic efficiency and problematically increase cyclic loadings that leads to increased fatigues. An advantage of using blades 19 with a section that is vertical or has a constant angle of outward radial tilt (as in the present concept) is that the blades can include Independent Pitch Control (IPC) to vary the blade pitch as the blade 19 rotates around the vertical axis of rotation as shown in FIG. 9. In an embodiment, as shown in FIG. 9 this blade pitch can be actuated at the rotation ring 7, similar to the hub-based pitch system of a HAWT. The blade pitch axis of rotation (along the blade span) can be set along the airfoil's average center of pressure (where the aerodynamic pitching moment is zero) to minimize the power required for pitch.

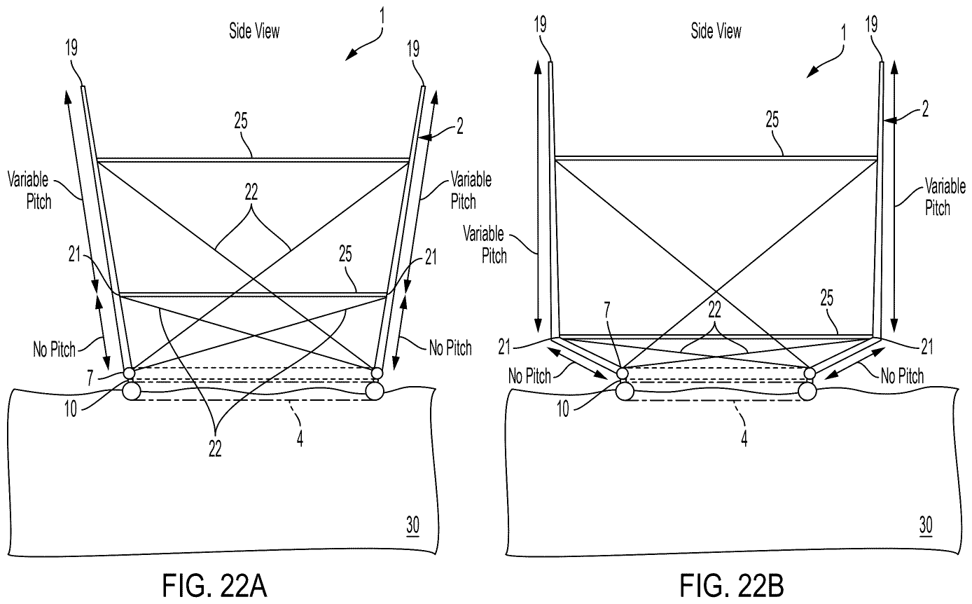

In an embodiment, another option is to employ partial pitch by leaving the lower portion of the blade fixed but pitching the upper portion as shown in FIGS. 22A-B. For example, one may actuate the blade pitch at the rotating spacer spanwise location with a pitch swivel connection 21.

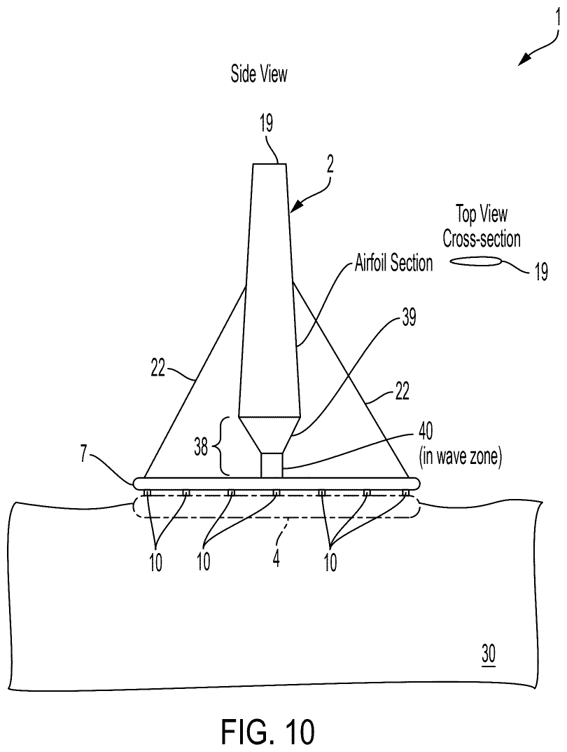

In an embodiment, since the turbine 1 is floating on water 30, there may be large waves that can impact the base of the rotating blade 19. For example, an offshore site may have a 50-year significant wave height of 10 meters. To avoid this wave loading on an aerodynamically-thin blade surface, the aerodynamic section (with an airfoil cross-section) of the blade 19 can start at an elevated height (e.g., above the maximum wave height), the lowest section of the blade 19 can include a more structural robust cross-sectional shape, such as the lower portion 38. The lower portion 38 may have a cylindrical section 40 having cylindrical cross-section for high structural robustness. The lower portion 38 may also include an intermediate transition section 39 that can have a cross-section that varies from a cylinder to an airfoil as shown in FIG. 10. In addition, in an embodiment, the blade 19 can have a high airfoil thickness (relative to chord length) at lower elevations to increase physical robustness and to support the blade. This transition from a cylindrical shape to a thin aerodynamic shape at higher blade spanwise locations is similar to the radial/spanwise transition used on a HAWT blade, where the inboard region starts at the hub with a cylindrical shape, followed by a transition section, and then the aerodynamic section smoothly transitions from a thick airfoil to a thin airfoil for the most outboard portions.

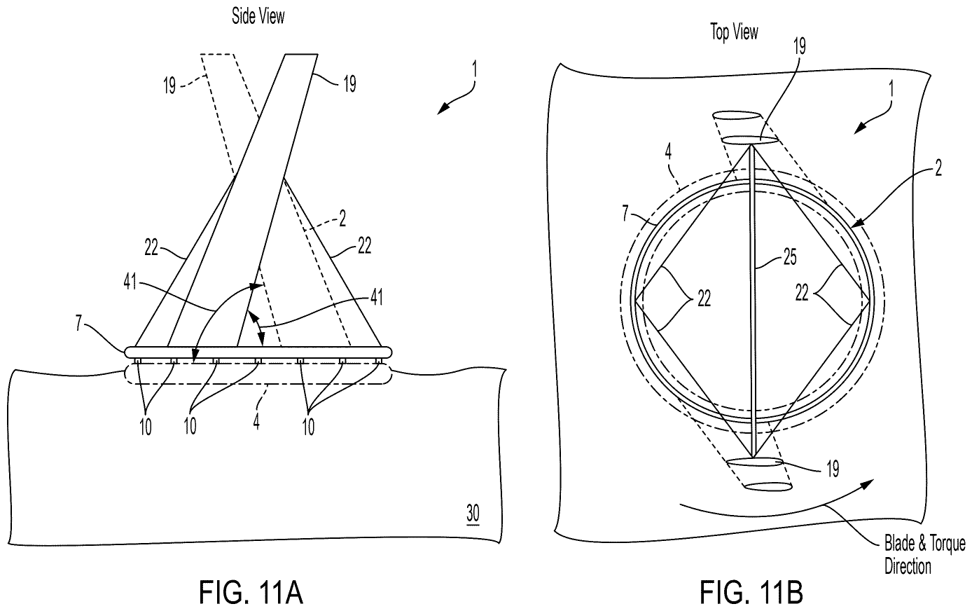

In an embodiment, the rotor blades 19 can also have a forward sweep as shown in FIGS. 11A-B to better structurally accommodate the forward torque that occurs along the blade 19 (especially at the higher elevations) during power generation operation.

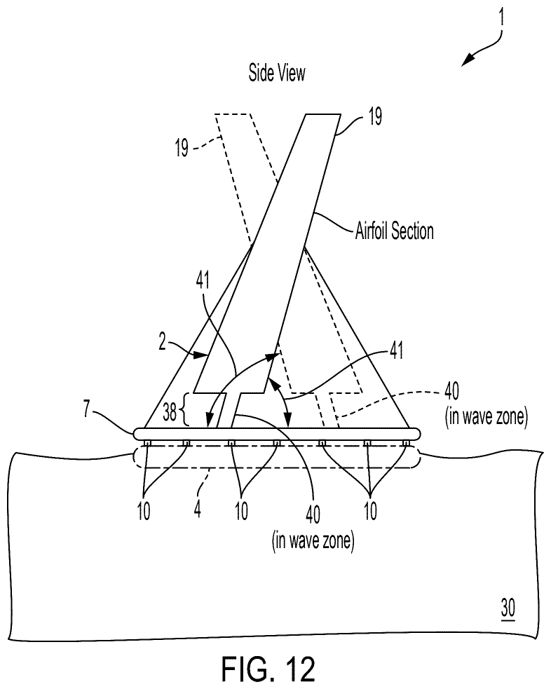

In an embodiment, to avoid possible wave impact on an aerodynamically-thin blade surface, a forward-swept blade 19 can also have aerodynamic portion of the blade 19 that starts at an elevated height combined with a cylindrical (more structurally robust) section 40 as shown in FIG. 12. An intermediate transition portion 39 as shown in FIG. 10 can also be included for a forward-swept blade.

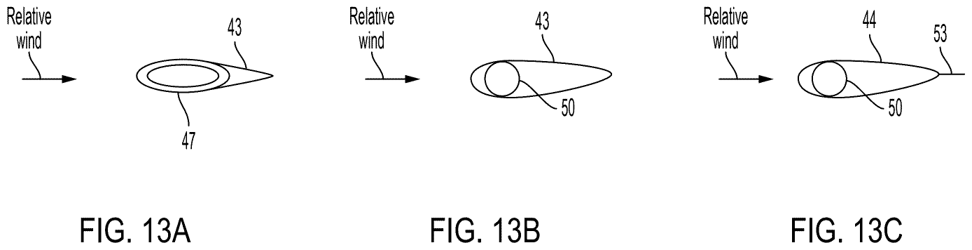

In an embodiment, the blade spacers 25 as well as blade cables 22 and tip cables 32 may see high relative wind speeds as the they rotate during power generation operation. This can create aerodynamic drag, which reduces the overall power provides by the rotation ring 7. To reduce this drag, the blade spacer 25 and the blade cables 22 and tip cables 32 can employ an aerodynamic fairing. For example, this can include a fixed fairing 43 as shown in FIGS. 13A-B. This can also include a free fairing 44 designed to rotate about the cable axis of the cable 22 with an airfoil shape that self-fairs to align with the wind and minimize drag. For example, one may use a self-aligning fairing shape as in U.S. Utility patent application Ser. No. 14/898,085, which is now U.S. Pat. No. 10,415,547, of which the disclosures are hereby incorporated by reference in their entirety. A self-aligning aerodynamic moment can also be achieved by adding an extended flat (streamwise) tail 53 as shown in FIG. 13C.

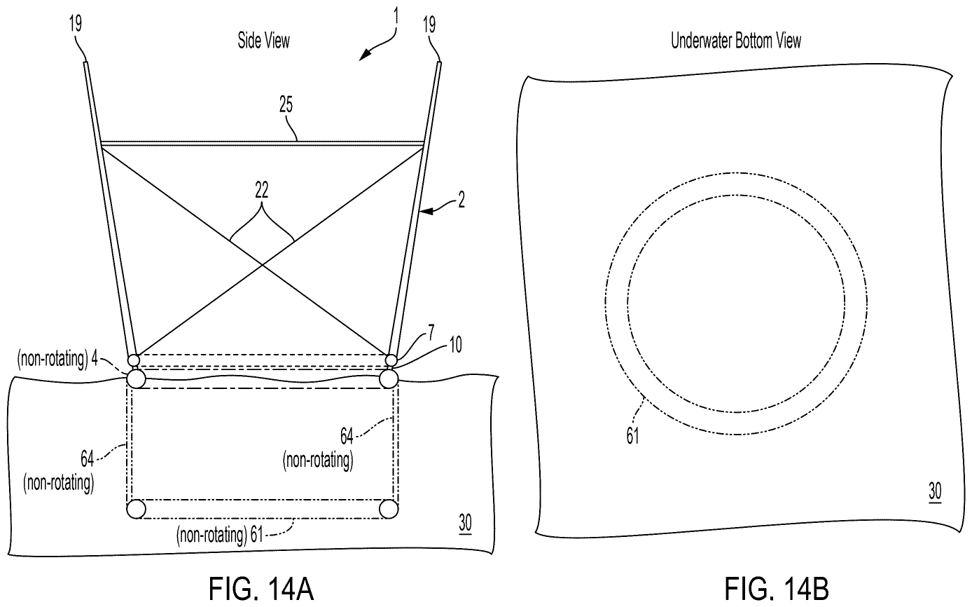

In an embodiment, to provide increased platform stability, a ballast ring 61 may be suspended below the buoyancy torus 4 by vertical ballast cables (or chains) 64 as shown in FIGS. 14A-B. There may be three or more such vertical ballast cables 64, of which may be non-rotating. The ballast ring 61 can be primarily composed of concrete to provide low-cost mass. The ballast ring 61 can be allowed to sway freely and reside at a depth consistent with the natural pitch frequency of the floating ring-based vertical-axis wind turbine (VAWT) 1, so that the ballast ring 61 can act as a Tuned Mass Damper. The ballast ring 61 can also reside at a much larger depth, so it provides increased stability and a low pitching frequency of the floating ring-based vertical-axis wind turbine (VAWT) 1 so that it is not highly affected by waves.

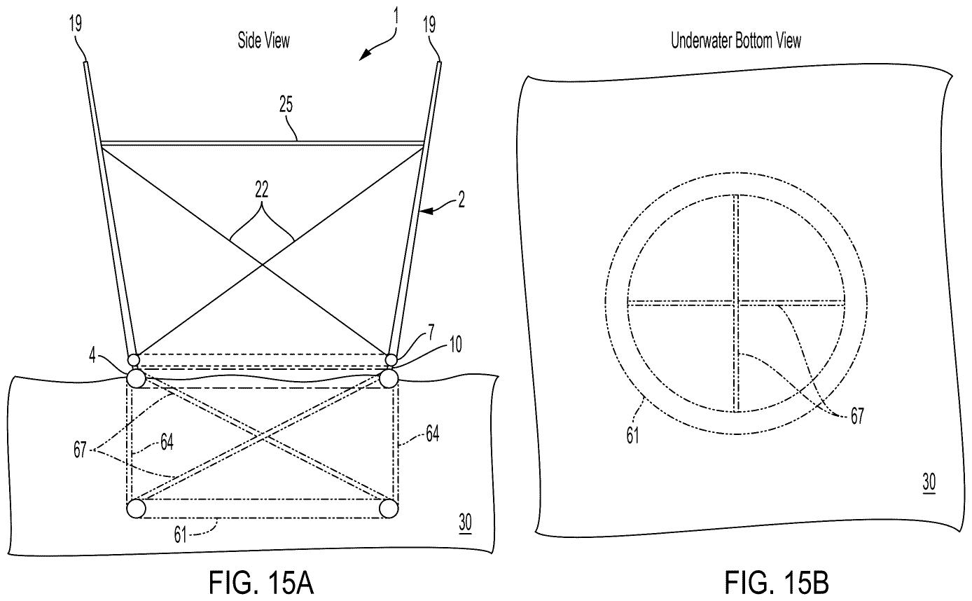

In an embodiment, the ballast ring 61 can also be connected to the buoyancy torus 4 with ballast cross cables 67 as shown in FIGS. 15A-B, so that the floating ring-based vertical-axis wind turbine (VAWT) 1 is effectively rigid (no swaying). These ballast cross cables 67 can be pre-tensioned so that that stay in tension when the floating ring-based vertical-axis wind turbine (VAWT) 1 is dynamically tilted relative to gravity. There may be three or more such ballast cross cables 67.

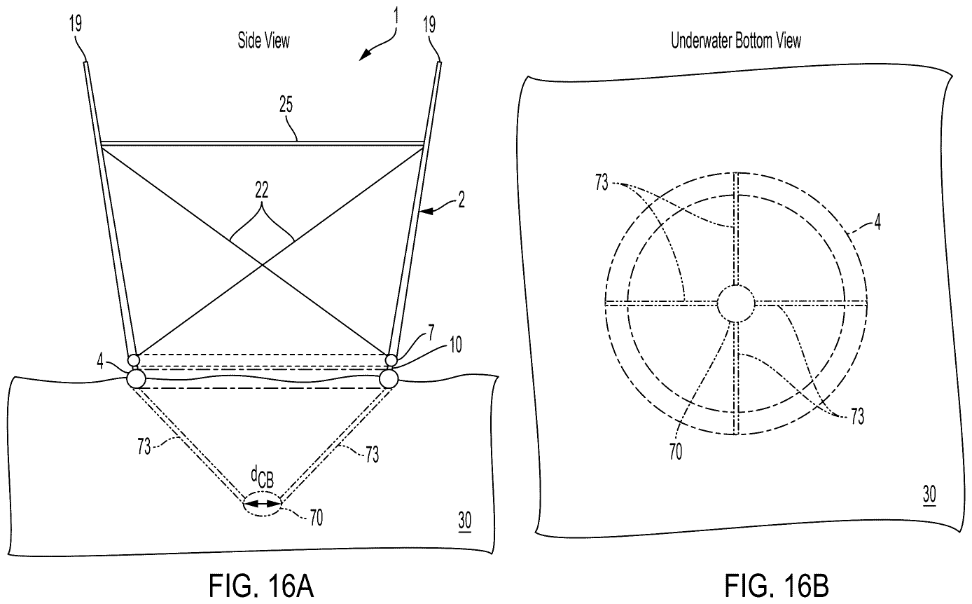

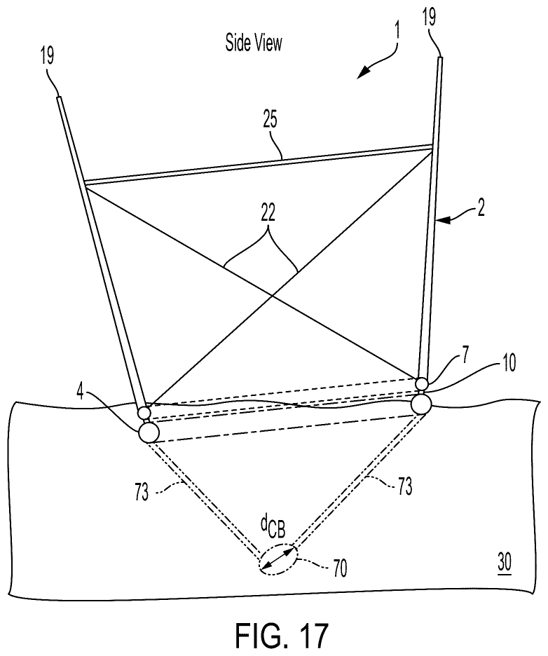

In an embodiment, another option to provide increased stability is to use a center ballast 70 as shown in FIG. 16, which is connected at its side by ballast cables 73 that angle outwards as they rise towards the buoyancy torus 4, where they are connected. There may be three or more such ballast cables 73. For example, FIGS. 16A-B show a configuration with four ballast cables 73. The angle of these ballast cables 73 and the diameter of the center ballast 70 (the diameter noted as d_{CB} in FIG. 16A) may be designed so that the ballast cables 73 stay in tension when the floating ring-based vertical-axis wind turbine (VAWT) 1 is dynamically tilted relative to gravity as shown in FIG. 17.

In addition, in an embodiment, the above ring-based VAWT 1 can also be placed on land to serve as an onshore wind turbine whereby the flotation and mooring systems are replaced by a foundation 31 in the ground. Due to the high speeds of the blades 19, this area may need to be fenced off for safety reasons. The foundation 31 may be a pad, mechanical structure, or footers, for example. In an example, the material of the foundation 31 may be concrete or steel.

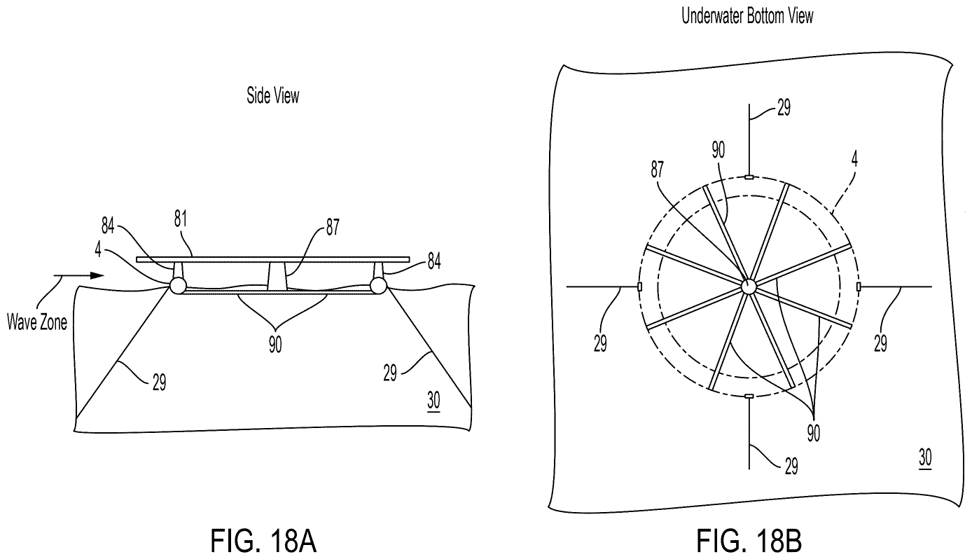

Furthermore, in an embodiment, a ring-based floatation system can be used to support a floating oil/gas offshore platforms as shown in FIGS. 18A-B. The platform 81 can be suspended above the wave zone by outer columns 84 and a central column 87, where the columns 84, 87 can have cylindrical cross-sections (on a horizontal plane) and may be tapered in the vertical direction). The central column 87 can attach to the buoyancy torus 4 with torus cables 90 as shown in FIGS. 18A-B. In the horizontal plane, the torus cables 90 can extend radially from the central column 87 as shown in FIG. 18B, with patterns similar to spokes on a bicycle wheel. Mooring lines 29 (connected on the sea/ocean/lake floor) can also attach to the buoyancy torus 4 to help anchor the platform 81.

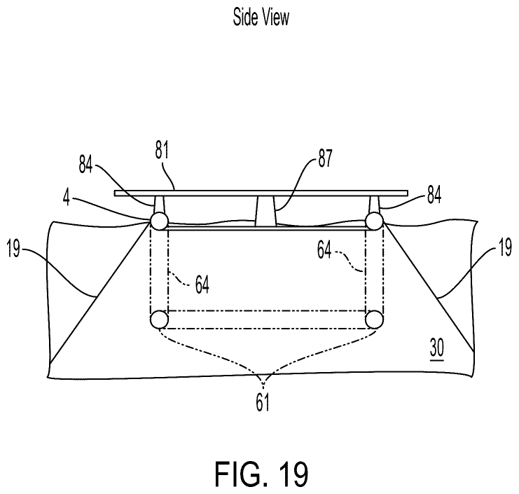

In an embodiment, to provide increased platform stability, a ballast ring 61 may be suspended below the buoyancy torus 4 by vertical ballast cables (or chains) 64 as shown in FIG. 19, based on the same concept as shown in FIGS. 14A-B. Other ballast options for this oil/gas floating offshore platform may include adding cross ballast cables 67 as shown in FIGS. 15A-B or using a single center ballast 70 as shown in FIGS. 16A-B.

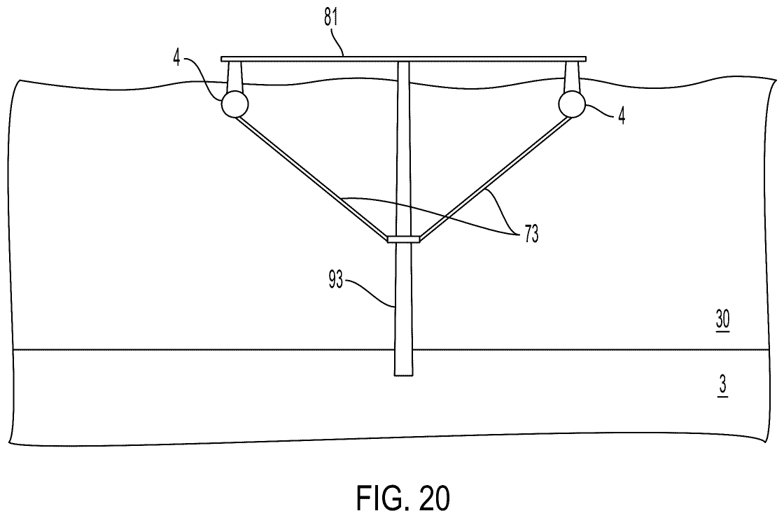

In an embodiment, another option to support a floating oil/gas offshore platforms 81 is to use a monopile 93 combined with a full-submerged buoyancy torus 4 as shown in FIG. 20. Angled buoyancy cables 73 can connect the buoyancy torus 4 to a lower portion of the monopile 93 to provide additional structural rigidity and to provide tension to keep the buoyancy torus 4 fully submerged as shown in FIG. 20. In an embodiment, the angled buoyancy cables 73 may be replaced with horizontally aligned buoyancy cables (not shown). In an embodiment, the monopile 93 can also be replaced with a truss system or a tri-pile/jacket system.

FIGS. 1A-B is a schematic side view (FIG. 1A) and top view (FIG. 1B) of a ring-based floating vertical-axis wind turbine (VAWT) 1 in an exemplary embodiment showing a cross-section of a buoyancy torus 4 (which is partially submerged) and a rotation ring 7 (which is not submerged), where the buoyancy torus 4 is connected by a rotational support system 10 (such as a rail 16 not shown in FIG. 1). In an embodiment, the buoyancy torus 4 vertically supports a rotating rail 8, which is attached to and supports the rotating rotation ring 7, which is attached to and supports two rotating turbine blades 19 (shown at a time when the blades are at left and right positions), where the blades 19 lean radially outward as they rise vertically and the resulting radially-outward forces are counter-acted by blade cables 22 and by a blade spacer 25, and where the rotation rail 8, rotation ring 7, blades 19, cables 22, and spacer 25 all rotate about a vertical (or nearly vertical) axis of rotation during power generation In an embodiment, it noted that FIG. 1A shows two cable per blades each attaching at two different elevations on the blade and both attaching at the opposite side of the rotation ring, while FIG. 1B shows a different cable embodiment showing two cable per blades both attaching at a single elevation on the blade and but then attaching at two different locations on the rotation ring 7. The general case for blade cables can include one or more cables per blade attaching at one or more blade elevations as well as at one or more locations on the rotation ring 7.

FIG. 2 is a schematic side view of a ring-based floating vertical-axis wind turbine (VAWT) 1 as in FIG. 1A in operation based on a wind that is blowing left-to-right showing the primary forces (with directions indicated by arrows) acting on the rotating blades 19, blade cables 22 (showing an example of one cable per blade attached to the opposite point on the rotation ring 7), and blade spacer 25 during operational conditions where the blade rotation about the vertical axis of rotation create torque and power as well as a downwind thrust force (to the right) and tension forces of the spacer 25 and blade cables 22 are illustrated.

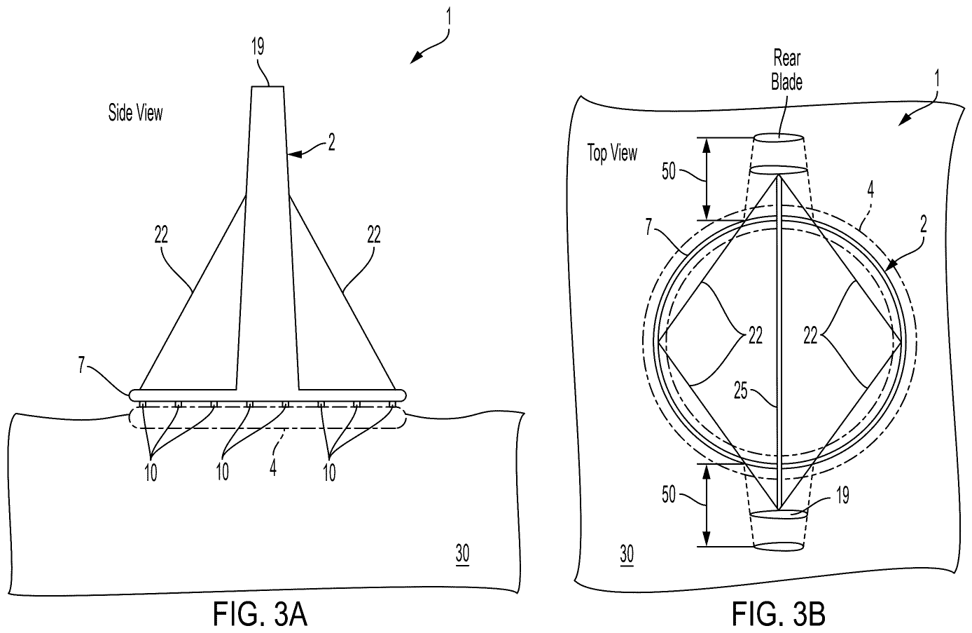

FIGS. 3A-B is a schematic side view (FIG. 3A) and top view (FIG. 3B) of a ring-based floating vertical-axis wind turbine (VAWT) 1 at a time when the blades 19 are now at front and back positions, showing that the chord of a blade 19 may decrease at higher elevations and showing the example of two blade cables 22 per blade 19, where the cables are attached at a single blade elevation but at two different points on the rotation ring 7 as in FIG. 1B.

FIGS. 4A-B is a schematic side view (FIG. 4A) as in FIG. 1A and a bottom view (FIG. 4B) to show four mooring lines 29, which prevent the buoyancy torus 4 from rotating during power generation.

FIGS. 5A-B are schematic top views of a ring-based floating vertical-axis wind turbine (VAWT) 1 with two different embodiments where FIG. 5A shows three blades 19 and three blade spacers 25, so the spacers form a triangle (as seen from above) and where there is one blade cable per blade that attaches at the opposite side of the rotation ring 7, while FIG. 5B shows a different option with four blades 19 and two blade spacers 25, which form a cross (as seen from above) and where there is two blade cables per blade where the cables attach at one location on the blade but at two different points of the rotation ring 7.

FIG. 6 is a schematic side view of a ring-based floating vertical-axis wind turbine (VAWT) 1 as in FIG. 2 but now including tip cables 32 to provide additional structural support to blades 19 to resist radially outward forces near the blade tips.

FIG. 7 is a schematic side view (FIG. 7A) and top view (FIG. 7B) (without blade cables 22 shown) of a ring-based floating vertical-axis wind turbine (VAWT) 1 as in FIG. 1 showing four electrical generators 35 attached to the buoyancy torus 4 and driven by the inside of the rotation ring 7 using a friction-drive system.

FIG. 8 is a schematic side view of two circular rotation rails 8 attached to the rotation ring 7, while the torus wheels 6 and respective axle 9 are situated below the rotation rails 8 and the axle 9 is supported on the buoyancy torus 4 connected by a support 5. The gravitational downward force of the rail on the wheels can be used to minimize slippage and the rotation of one or more wheel axles can be used as one or more shafts to drive one or more electrical generators.

FIG. 9 is a schematic enlarged top partial view of a single blade 19 (without blade cables 22 or blade spacers 25 being shown) with a system that allows allowing for variable pitch angle 20 of the blade 19, where this angle can be adjusted as the blade 19 rotates about the vertical axis of rotation with an Independent Pitch Control system.

FIG. 10 is a schematic side view of a ring-based floating vertical-axis wind turbine (VAWT) 1 as in FIG. 3 but with an airfoil horizontal cross-section part of the blade 19 for the upper most portion of the blade 19 and a circular horizontal cross-section 40 at a lower portion 38 (which is the wave region where waves may impact the blade) and an intermediate transition section 39 whose horizontal cross section transitions from a circle to an airfoil at increasing elevations.

FIGS. 11A-B is a schematic side view (FIG. 11A) and top view (FIG. 11B) as in FIG. 3 but now showing the blades 19 with a forward blade sweep angle 41 at higher elevations (into the direction of rotation).

FIG. 12 is a schematic side view of a ring-based floating vertical-axis wind turbine (VAWT) 1 as in FIG. 10 but without a blade intermediate transition section 39 and with now including a forward blade arrangement as in FIG. 11A.

FIGS. 13A-C schematically show aerodynamic fairings configured to reduce drag, where the fixed fairing 43 (as shown in FIG. 13A) is fixed to a blade spacer 25; the fixed fairing 43 (as shown in FIG. 13B) is fixed around a blade cable 22, and the free fairing 44 (as shown in FIG. 13C) is freely supported around a blade cable 22 and includes a flat tail 53 so that the free fairing 44 self-aligns aerodynamically with the oncoming wind to minimize drag.

FIGS. 14A-B is a schematic side view (FIG. 14A) and bottom view (FIG. 14B) (from underwater) of a ring-based floating vertical-axis wind turbine (VAWT) 1 similar to FIG. 4 (without showing the mooring lines) but with the addition of an underwater circular ballast ring 61 that is connected to the buoyancy torus 4 with vertical ballast cables 64, which allows the underwater ballast ring 61 to sway as in a pendulum with respect to the buoyancy torus.

FIGS. 15A-B is a schematic side view (FIG. 15A) and bottom view (FIG. 15B) (from underwater) of a ring-based floating vertical-axis wind turbine (VAWT) 1 as similar to FIGS. 14A-B, respectively, but with the addition of underwater cross ballast cables 67 which may be pre-tensioned so that the underwater ballast ring 61 is rigidly attached to the buoyancy torus 4, so it does not sway with respect to the buoyancy torus.

FIGS. 16A-B is a schematic side view (FIG. 16A) and bottom view (FIG. 16B) (from underwater) of a ring-based floating vertical-axis wind turbine (VAWT) 1 similar to FIGS. 14A-B, respectively, but with a center underwater ballast 70 that is connected to the buoyancy torus 4 with underwater angled ballast cables 73.

FIG. 17 is a schematic side view of a ring-based floating vertical-axis wind turbine (VAWT) 1 similar to FIG. 16A showing the rotation ring 7 at an angle to the horizon, where the underwater angled ballast cables 73 are fixed to the underwater center ballast 70 so the ballast can sway so that the underwater angled ballast cables 73 can stay be in tension (to avoid snap loads on the underwater angled ballast cables 73).

FIGS. 18A-B is a schematic side view (FIG. 18A) and a bottom view (FIG. 18B) (from underwater) of an oil/gas offshore platform 81 which is elevated above the wave zone or region and is supported vertically by outer columns 84 and a central column 87, where the outer columns 84 rest on the buoyancy torus 4, which provides buoyancy support, where the central column 87 is partially submerged and sealed to provide additional buoyancy support, where buoyancy torus cables 90 can connect the buoyancy torus 4 to the bottom of the central column 87 to provide additional structural support, and where mooring lines 29 serve to help anchor the platform 81.

FIG. 19 is a schematic side view of an oil/gas offshore platform 81 similar to FIG. 18A, but with the additional of an underwater circular ballast ring 61 (similar to FIG. 14A) and underwater vertical ballast cables 64 (similar to FIG. 14A) to provide additional stability.

FIG. 20 is a schematic side view of an oil/gas offshore platform 81 similar to FIG. 18A, but with underwater central column 87 (of FIG. 18A) replaced by a monopile 93 (so mooring lines 29 are no longer needed) and the monopile is connected to the buoyancy torus 4 with underwater angled buoyancy cables 73, and where the buoyancy torus is now fully submerged. In an embodiment, similar to FIG. 18A the oil/gas offshore platform 81 is elevated above the wave zone or region and is supported vertically by outer columns 84 and the monopile 93, where the outer columns 84 rest on the buoyancy torus 4, which provides buoyancy support and the monopile 93 is partially submerged and sealed to provide additional buoyancy support.

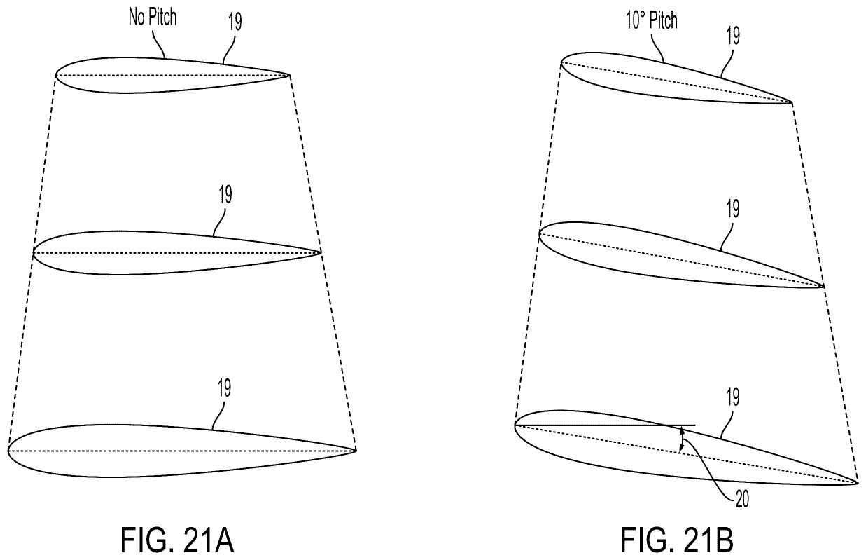

FIGS. 21A-B schematically showing a top view cross sections of a blade 19 at three different elevations (where blade cables 22 and blade spacers 25 are not shown) for a system with no pitch control so the blade chord is always tangent to a circle about a vertical axis of rotation (FIG. 21A) vs. a system with variable pitch control (FIG. 21B) for fixed pitch where the blade chord angle at this instance is pitched at ten degrees away from away a circle about a vertical axis of rotation and this angle can generally vary as the blade rotates via an Independent Pitch Control system.

FIG. 22A-B schematically show a side view of the turbine lower portion of the blade 19 with no pitch control (below point 21) and an upper portion of the blade 19 (above point 21) with adjustable/variable pitch, where, as shown in FIG. 22A, the both portion of the blade have the same a radially outward angle at the point 21. In an embodiment, FIG. 22B is similar to FIG. 22A but where the lower portion of the blade 19 (below point 21) with no pitch control has a larger radially outward angle while the upper portion of the blade 19 (above point 21) with variable pitch is nearly vertical.

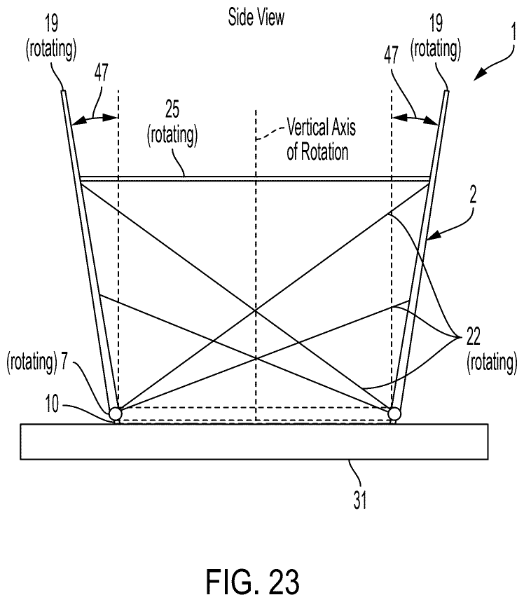

FIG. 23 is a schematic side view of a ring-based onshore vertical-axis wind turbine (VAWT) 1 similar to the ring-based floating vertical-axis wind turbine (VAWT) 1 as in FIG. 1A but which is supported by a foundation 31 rather than a buoyance torus.

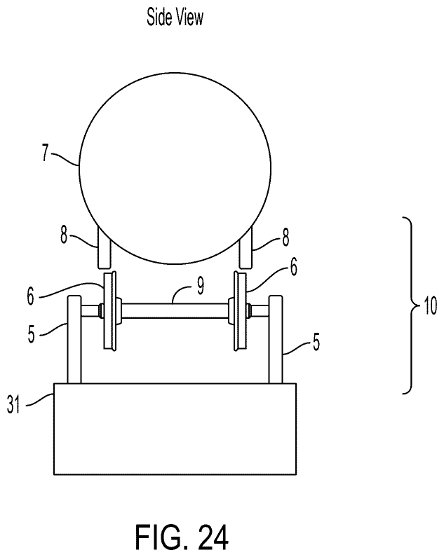

FIG. 24 is a schematic side view of a portion of ring-based onshore vertical-axis wind turbine (VAWT) 1 similar to the portion of the ring-based floating vertical-axis wind turbine (VAWT) 1 as in FIG. 8 but which is supported by a foundation 31 rather than a buoyance torus.

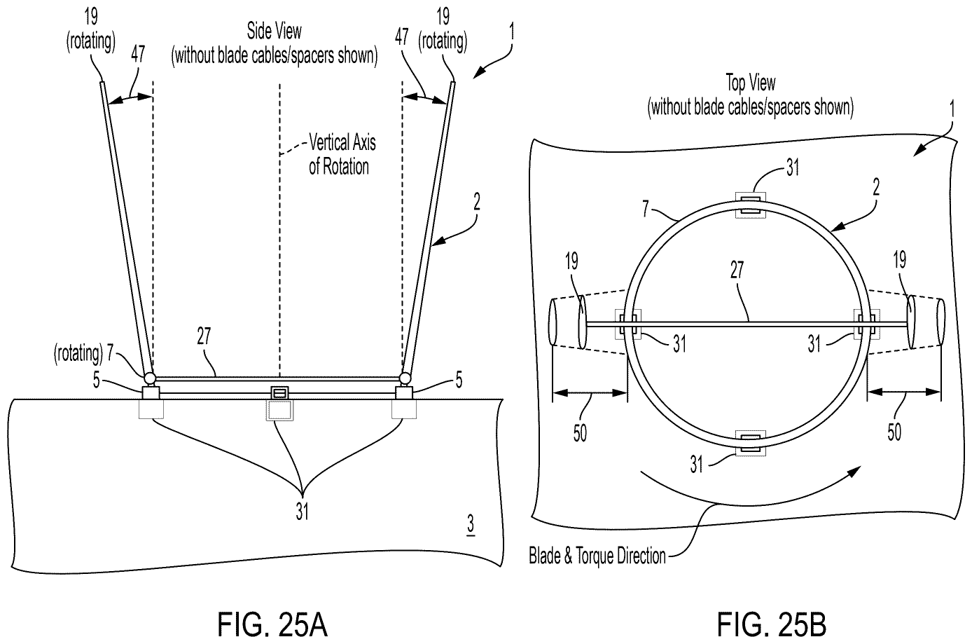

FIGS. 25A-B is a schematic side view (FIG. 25A) and top view (FIG. 25B) of a ring-based onshore vertical-axis wing turbine (VAWT) 1 similar to the schematic side view (FIG. 1A) and top view (FIG. 1B), respectively, of a ring-based floating vertical-axis wind turbine (VAWT) 1 but which is supported by a foundation 31 rather than a buoyance torus.

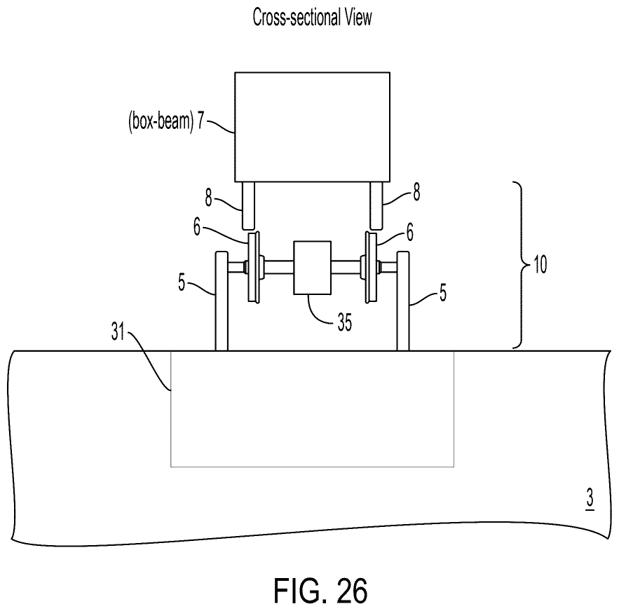

FIG. 26 is a schematic side view of a portion of ring-based onshore vertical-axis wind turbine (VAWT) 1 similar to FIG. 24 with a circular rotation ring 7 of the box-beam type and a generator 35.

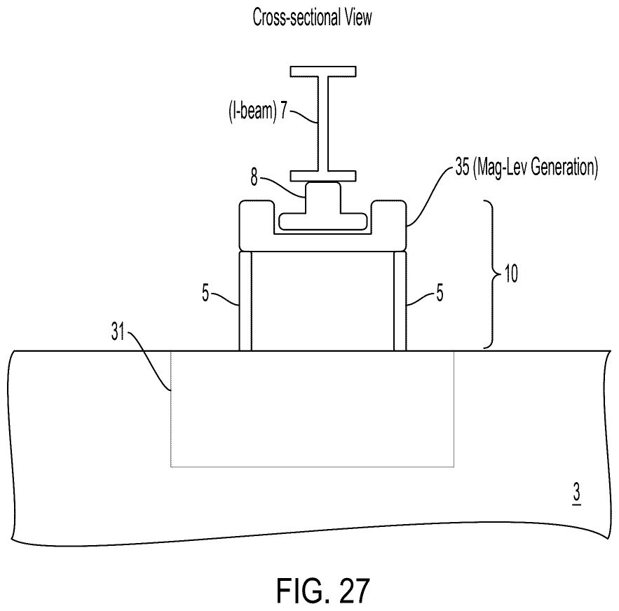

FIG. 27 is a schematic side view of a portion of ring-based onshore vertical-axis wind turbine (VAWT) 1 similar to FIG. 24 with a circular rotation ring 7 of the I-beam type and a generator 35 of the Mag-Lev type.

Although example embodiments of the present disclosure are explained in some instances in detail herein, it is to be understood that other embodiments are contemplated. Accordingly, it is not intended that the present disclosure be limited in its scope to the details of construction and arrangement of components set forth in the following description or illustrated in the drawings. The present disclosure is capable of other embodiments and of being practiced or carried out in various ways.

It should be appreciated that any element, part, section, subsection, or component described with reference to any specific embodiment above may be incorporated with, integrated into, or otherwise adapted for use with any other embodiment described herein unless specifically noted otherwise or if it should render the embodiment device non-functional. Likewise, any step described with reference to a particular method or process may be integrated, incorporated, or otherwise combined with other methods or processes described herein unless specifically stated otherwise or if it should render the embodiment method nonfunctional. Furthermore, multiple embodiment devices or embodiment methods may be combined, incorporated, or otherwise integrated into one another to construct or develop further embodiments of the invention described herein.

It should be appreciated that any of the components or modules referred to with regards to any of the present invention embodiments discussed herein, may be integrally or separately formed with one another. Further, redundant functions or structures of the components or modules may be implemented. Moreover, the various components may be communicated locally and/or remotely with any user/operator/customer/client or machine/system/computer/processor. Moreover, the various components may be in communication via wireless and/or hardwire or other desirable and available communication means, systems and hardware. Moreover, various components and modules may be substituted with other modules or components that provide similar functions.

It should be appreciated that the device and related components discussed herein may take on all shapes along the entire continual geometric spectrum of manipulation of x, y and z planes to provide and meet the environmental, anatomical, and structural demands and operational requirements. Moreover, locations and alignments of the various components may vary as desired or required.

It should be appreciated that various sizes, dimensions, contours, rigidity, shapes, flexibility and materials of any of the components or portions of components in the various embodiments discussed throughout may be varied and utilized as desired or required.

It should be appreciated that while some dimensions are provided on the aforementioned figures, the device may constitute various sizes, dimensions, contours, rigidity, shapes, flexibility and materials as it pertains to the components or portions of components of the device, and therefore may be varied and utilized as desired or required.

It must also be noted that, as used in the specification and the appended claims, the singular forms “a,” “an” and “the” include plural referents unless the context clearly dictates otherwise. Ranges may be expressed herein as from “about” or “approximately” one particular value and/or to “about” or “approximately” another particular value. When such a range is expressed, other exemplary embodiments include from the one particular value and/or to the other particular value.

By “comprising” or “containing” or “including” is meant that at least the named compound, element, particle, or method step is present in the composition or article or method, but does not exclude the presence of other compounds, materials, particles, or method steps, even if the other such compounds, material, particles, or method steps have the same function as what is named.

In describing example embodiments, terminology will be resorted to for the sake of clarity. It is intended that each term contemplates its broadest meaning as understood by those skilled in the art and includes all technical equivalents that operate in a similar manner to accomplish a similar purpose. It is also to be understood that the mention of one or more steps of a method does not preclude the presence of additional method steps or intervening method steps between those steps expressly identified. Steps of a method may be performed in a different order than those described herein without departing from the scope of the present disclosure. Similarly, it is also to be understood that the mention of one or more components in a device or system does not preclude the presence of additional components or intervening components between those components expressly identified.

Some references, which may include various patents, patent applications, and publications, are cited in a reference list and discussed in the disclosure provided herein. The citation and/or discussion of such references is provided merely to clarify the description of the present disclosure and is not an admission that any such reference is “prior art” to any aspects of the present disclosure described herein. In terms of notation, “[n]” corresponds to the n^{th} reference in the list. All references cited and discussed in this specification are incorporated herein by reference in their entireties and to the same extent as if each reference was individually incorporated by reference.

The term “about,” as used herein, means approximately, in the region of, roughly, or around. When the term “about” is used in conjunction with a numerical range, it modifies that range by extending the boundaries above and below the numerical values set forth. In general, the term “about” is used herein to modify a numerical value above and below the stated value by a variance of 10%. In one aspect, the term “about” means plus or minus 10% of the numerical value of the number with which it is being used. Therefore, about 50% means in the range of 45%-55%. Numerical ranges recited herein by endpoints include all numbers and fractions subsumed within that range (e.g., 1 to 5 includes 1, 1.5, 2, 2.75, 3, 3.90, 4, 4.24, and 5). Similarly, numerical ranges recited herein by endpoints include subranges subsumed within that range (e.g., 1 to 5 includes 1-1.5, 1.5-2, 2-2.75, 2.75-3, 3-3.90, 3.90-4, 4-4.24, 4.24-5, 2-5, 3-5, 1-4, and 2-4). It is also to be understood that all numbers and fractions thereof are presumed to be modified by the term “about.”

### EXAMPLES

Practice of an aspect of an embodiment (or embodiments) of the invention will be still more fully understood from the following examples and experimental results, which are presented herein for illustration only and should not be construed as limiting the invention in any way.
Example 1. A ring-based Vertical-Axis Wind Turbine (VAWT) system, comprising:
   a circular rotor, wherein said circular rotor comprises a rotation ring and two or more rotor blades attached thereto;
   wherein said rotation ring is configured to encircle and rotate about a vertical axis or nearly-vertical axis;
   wherein said attached rotor blades extend vertically upwards from said rotation ring, and optionally, are configured to be in a radially outward angle as they extend upwards to increases the swept area at higher elevations, wherein in said radially outward angle defines a radially-outward blade tilt angle; and
   wherein said rotor blades are configured to be driven aerodynamically by the wind so that said rotor blades and said rotation ring can rotate about the same axis of rotation, which is the vertical axis of rotation or nearly-vertical axis of rotation, to provide mechanical rotational power from the wind.
Example 2. The VAWT system of example 1 configured to operate as a floating offshore VAWT system, wherein said system further comprising:
   a buoyancy torus that is configured to be non-rotating;
   wherein said buoyancy torus has an axis that is the same axis as said axis of rotation of said rotation ring and is configured to vertically support said circular rotor; and
   wherein said buoyancy torus is configured to support one or more electrical generators that are configured to extract rotational mechanical power from said circular rotor.
Example 3. The VAWT system of example 1 configured to operate as an onshore VAWT system, wherein said system further comprising:
   a foundation;
   wherein said foundation is configured to vertically support said rotation ring;
   wherein said foundation does not rotate during power generation; and
   wherein said foundation supports said one or more generators that are configured to extract the rotational mechanical power from said circular rotor.
Example 4. The VAWT system according to examples 1, 2, or 3, wherein said rotor blades are attached to each other at an upper portion of said rotor blades by one or more blade spacers (horizontally-oriented struts) so that the horizontal distance between said rotor blades at this vertical location is approximately fixed.
Example 5. The VAWT system according to examples 1, 2, or 3, further comprising blade cables, wherein said blade cables are attached to one or more spanwise locations along said rotor blades and extend downward at an angle to attach to one or more locations on the said rotation ring.
Example 6. The VAWT system according to example 5, wherein said radially-outward blade tilt angle (from the vertical) is configured so that gravitational forces and centrifugal forces together are greater than the maximum downwind thrust force at rated power conditions so that said blade cables are always in tension.
Example 7. The VAWT system of example 4, further comprising tip cables, wherein said tip cables are attached near the top of one said rotor blades and extend downward at an angle to attach to said blade spacer of another said rotor blade so that the blade tip deflections can be reduced.
Example 8. The VAWT system of examples 2 or 3, further comprising one or more rotation ring rails that are fixed to said rotation ring so the that said rotation ring rails rotate about the same axis of rotation and at the same RPM as that of said rotation ring.
Example 9. The VAWT system of example 8, further comprising:
   wheels; and
   wherein said wheels are located below respective said rotation ring rails and configured to support the vertical load of said circular rotor and where the rotation of said rotation ring rails causes said wheels to rotate and where one or more of these said wheels are used to drive one or more of said electrical generators.
Example 10. The VAWT system of examples 2 or 3, wherein:
   said one or more electrical generators are based on a magnetic field between electrical components on said rotation ring and electrical components on said buoyancy torus or said foundation, both of which are non-rotating.
Example 11. The VAWT system of examples 1, 2, or 3, wherein said rotor blades or an upper portion of said rotor blades are configured to employ Independent Pitch Control to vary blade pitch angle (and thus instantaneous aerodynamic angle of attack) as said rotor blades rotate.
Example 12. The VAWT system of example 2, wherein a lower part of said rotor blade, in a wave zone, has a circular cross-section for structural efficiency and water wave resistance while an upper portion of said rotor blade, above the wave zone, has an airfoil cross-section to produce aerodynamic torque due to the wind.
Example 13. The VAWT system of examples 1, 2, or 3, wherein said rotor blade is configured to have a forward sweep as defined by a blade sweep angle 41 into the direction of rotation to increase structural efficiency.
Example 14. The VAWT system of examples 1, 2, or 3, further comprising:
   one or more of blade spacers, said blade cables, or said tip cables; and
   aerodynamic fairings disposed on one or more of said blade spacers, said blade cables, or said tip cables to employ an aerodynamic fairing to minimize aerodynamic drag.
Example 15. The VAWT system of example 14, wherein said fairings are configured to be free to rotate about one or more of said blade spacers, blade cables, or said tip cables and, optionally, said fairings may include a flat tail to ensure said fairings are self-aligning to the relative air flow.
Example 16. The VAWT system of example 2, further comprising a circular ballast ring wherein said ballast ring is attached to said buoyancy torus 4 using vertical ballast cables.
Example 17. The VAWT system of example 16, wherein the length of said vertical ballast cables is configured to be adjustable wherein an adjustment of said vertical ballast cables is configured to provide a pendulum-swaying motion of said ballast ring so as to act as a Tuned Mass Damper.
Example 18. The VAWT system of example 16, further comprising ballast cross cables wherein a connection of the ballast ring to the buoyancy torus is at least substantially rigid.
Example 19. The VAWT system of example 18, wherein said ballast cross cables are configured to be pre-tensioned so that they remain in tension during most wave and wind loading events.
Example 20. The VAWT system of example 2, further comprising a center ballast that is attached to the buoyancy torus 4 using angled ballast cables and where the connections to said center ballast allow said angled ballast cables to remain in tension during most wave and wind loading events incurred by said system.
Example 21. The VAWT system of example 2, wherein:
   said buoyancy torus has an external ring torus shape or is composed of a series of eight or more cylindrical sections to approximate a ring torus shape;
   said buoyancy torus is thin-walled to contain air inside and is water-tight and semi-submerged to provide buoyancy as a floating wind turbine platform; and
   said buoyancy torus is inhibited from rotating during power generation by mooring lines.
Example 22. The VAWT system of example 1, further comprising one or more rotation ring rails that are fixed to said rotation ring so the that said rotation ring rails rotate about the same axis of rotation and at the same RPM as that of said rotation ring.
Example 23. The VAWT system of example 22, further comprising:
   wheels;
   wherein said buoyancy torus is configured to support one or more electrical generators that are configured to extract rotational mechanical power from said circular rotor; and
   wherein said wheels are located below respective said rotation ring rails and configured to support the vertical load of said circular rotor and where the rotation of said rotation ring rails causes said wheels to rotate and where one or more of these said wheels are used to drive one or more of said electrical generators
Example 24 A ring-based floating system, wherein said system comprises:
   an oil/gas platform which is above a wave zone;
   a buoyancy torus, wherein said buoyancy torus include an external ring torus shape or a series of eight or more cylindrical sections to approximate a ring torus shape and wherein said buoyancy torus is thin-walled to contain air inside and is water-tight and semi-submerged to provide buoyancy;
   outer columns or trusses which attach and provide vertical support between the platform above and the buoyancy torus below; and
   mooring lines that are attached to said buoyancy torus, which serve to help anchor and stabilize said platform
Example 25. The system of example 24, further comprising a central column which is partially submerged to provide further buoyancy to support the platform, and wherein horizontal or nearly-horizontal cables are configured to attach the buoyancy torus to said central column to provide additional structural integrity.
Example 26. The system of example 24, further comprising a circular ballast ring that is attached to said buoyancy torus using vertical ballast cables and wherein said ballast ring hangs below said buoyancy torus.
Example 27. The system of example 24, further comprising:
   a monopile, jacket, or truss configured to be fixed to a bottom wherein said monopile, jacket, or truss configured to provide vertical support to said platform; and
   buoyancy cables wherein said buoyancy cables are attached to said monopile, jacket, or truss at a lower depth configured to fully submerge said buoyancy torus.
Example 28. The method of using/operating any of the systems (devices, structures, apparatuses, systems, or material) or its components or sub-components provided in any one or more of examples 1-27, in whole or in part.
Example 29. The method of manufacturing any of the systems (devices, structures, apparatuses, systems, or material) or its components or sub-components provided in any one or more of examples 1-27, in whole or in part.
Example 30. A non-transitory machine readable medium including instructions for operating said VAWT system, which when executed by a machine, cause the machine to operate any of the systems or methods provided in any one or more of examples 1-29.

Each of these non-limiting examples can stand on its own, or can be combined in various permutations or combinations with one or more of the other examples. Each of these non-limiting examples can stand on its own, or can be combined in various permutations or combinations with one or more of the embodiments disclosed herein.

### REFERENCES

The devices, systems, apparatuses, modules, compositions, articles of manufacture, materials, computer program products, non-transitory computer readable medium, and methods of various embodiments of the invention disclosed herein may utilize aspects (such as devices, apparatuses, modules, systems, compositions, articles of manufacture, materials, computer program products, non-transitory computer readable medium, and methods) disclosed in the following references, applications, publications and patents and which are hereby incorporated by reference herein in their entirety (and which are not admitted to be prior art with respect to the present invention by inclusion in this section).
1. International Patent Application Serial No. PCT/US2024/044594, entitled “RING-BASED FLOATING AND FIXED-FLOATING WIND TURBINE PLATFORMS”, filed Aug. 30, 2024.
2. U.S. Utility patent application Ser. No. 14/898,085, entitled “2-D FAIRING FOR A WIND TURBINE TOWER”, filed Dec. 11, 2015; U.S. Pat. No. 10,415,547, issued Sep. 17, 2019; Publication No. US-2016-0138567-A1, May 19, 2016.
3. International Patent Application Serial No. PCT/US2014/043410, entitled “2-D FAIRING FOR A WIND TURBINE TOWER”, filed Jun. 20, 2014; Publication No. WO 2014/205348, Dec. 24, 2014.

In summary, while the present invention has been described with respect to specific embodiments, many modifications, variations, alterations, substitutions, and equivalents will be apparent to those skilled in the art. The present invention is not to be limited in scope by the specific embodiment described herein. Indeed, various modifications of the present invention, in addition to those described herein, will be apparent to those of skill in the art from the foregoing description and accompanying drawings. Accordingly, the invention is to be considered as limited only by the spirit and scope of the disclosure (and claims) including all modifications and equivalents.

Still other embodiments will become readily apparent to those skilled in this art from reading the above-recited detailed description and drawings of certain exemplary embodiments. It should be understood that numerous variations, modifications, and additional embodiments are possible, and accordingly, all such variations, modifications, and embodiments are to be regarded as being within the spirit and scope of this application. For example, regardless of the content of any portion (e.g., title, field, background, summary, abstract, drawing figure, etc.) of this application, unless clearly specified to the contrary, there is no requirement for the inclusion in any claim herein or of any application claiming priority hereto of any particular described or illustrated activity or element, any particular sequence of such activities, or any particular interrelationship of such elements. Moreover, any activity can be repeated, any activity can be performed by multiple entities, and/or any element can be duplicated. Further, any activity or element can be excluded, the sequence of activities can vary, and/or the interrelationship of elements can vary. Unless clearly specified to the contrary, there is no requirement for any particular described or illustrated activity or element, any particular sequence or such activities, any particular size, speed, material, dimension or frequency, or any particular interrelationship of such elements. Accordingly, the descriptions and drawings are to be regarded as illustrative in nature, and not as restrictive. Moreover, when any number or range is described herein, unless clearly stated otherwise, that number or range is approximate. When any range is described herein, unless clearly stated otherwise, that range includes all values therein and all sub ranges therein. Any information in any material (e.g., a United States/foreign patent, United States/foreign patent application, book, article, etc.) that has been incorporated by reference herein, is only incorporated by reference to the extent that no conflict exists between such information and the other statements and drawings set forth herein. In the event of such conflict, including a conflict that would render invalid any claim herein or seeking priority hereto, then any such conflicting information in such incorporated by reference material is specifically not incorporated by reference herein.

What is claimed is:

1. A ring-based Vertical-Axis Wind Turbine (VAWT) system, comprising:
a circular rotor, wherein said circular rotor comprises a rotation ring and two or more rotor blades attached thereto;
wherein said rotation ring is configured to encircle and rotate about a vertical axis or nearly-vertical axis;
wherein said attached rotor blades extend vertically upwards from said rotation ring, and optionally, are configured to be in a radially outward angle as they extend upwards to increases the swept area at higher elevations, wherein in said radially outward angle defines a radially-outward blade tilt angle; and
wherein said rotor blades are configured to be driven aerodynamically by the wind so that said rotor blades and said rotation ring can rotate about the same axis of rotation, which is the vertical axis of rotation or nearly-vertical axis of rotation, to provide mechanical rotational power from the wind.

2. The VAWT system of claim 1 configured to operate as a floating offshore VAWT system, wherein said system further comprising:
a buoyancy torus that is configured to be non-rotating;
wherein said buoyancy torus has an axis that is the same axis as said axis of rotation of said rotation ring and is configured to vertically support said circular rotor; and
wherein said buoyancy torus is configured to support one or more electrical generators that are configured to extract rotational mechanical power from said circular rotor.

3. The VAWT system of claim 1 configured to operate as an onshore VAWT system, wherein said system further comprising:
a foundation;
wherein said foundation is configured to vertically support said rotation ring;
wherein said foundation does not rotate during power generation; and
wherein said foundation supports said one or more generators that are configured to extract the rotational mechanical power from said circular rotor.

4. The VAWT system according to claims 1, 2, or 3, wherein said rotor blades are attached to each other at an upper portion of said rotor blades by one or more blade spacers so that the horizontal distance between said rotor blades at this vertical location is approximately fixed.

5. The VAWT system according to claims 1, 2, or 3, further comprising blade cables, wherein said blade cables are attached to one or more spanwise locations along said rotor blades and extend downward at an angle to attach to one or more locations on the said rotation ring.

6. The VAWT system according to claim 5, wherein said radially-outward blade tilt angle is configured so that gravitational forces and centrifugal forces together are greater than the maximum downwind thrust force at rated power conditions so that said blade cables are always in tension.

7. The VAWT system of claim 4, further comprising tip cables, wherein said tip cables are attached near the top of one said rotor blades and extend downward at an angle to attach to said blade spacer of another said rotor blade so that the blade tip deflections can be reduced.

8. The VAWT system of claims 2 or 3, further comprising one or more rotation ring rails that are fixed to said rotation ring so the that said rotation ring rails rotate about the same axis of rotation and at the same RPM as that of said rotation ring.

9. The VAWT system of claim 8, further comprising:
wheels; and
wherein said wheels are located below respective said rotation ring rails and configured to support the vertical load of said circular rotor and where the rotation of said rotation ring rails causes said wheels to rotate and where one or more of these said wheels are used to drive one or more of said electrical generators.

10. The VAWT system of claims 2 or 3, wherein:
said one or more electrical generators are based on a magnetic field between electrical components on said rotation ring and electrical components on said buoyancy torus or said foundation, both of which are non-rotating.

11. The VAWT system of claims 1, 2, or 3, wherein said rotor blades or an upper portion of said rotor blades are configured to employ Independent Pitch Control to vary blade pitch angle as said rotor blades rotate.

12. The VAWT system of claim 2, wherein a lower part of said rotor blade, in a wave zone, has a circular cross-section for structural efficiency and water wave resistance while an upper portion of said rotor blade, above the wave zone, has an airfoil cross-section to produce aerodynamic torque due to the wind.

13. The VAWT system of claims 1, 2, or 3, wherein said rotor blade is configured to have a forward sweep as defined by a blade sweep angle 41 into the direction of rotation to increase structural efficiency.

14. The VAWT system of claims 1, 2, or 3, further comprising:
one or more of blade spacers, said blade cables, or said tip cables; and
aerodynamic fairings disposed on one or more of said blade spacers, said blade cables, or said tip cables to employ an aerodynamic fairing to minimize aerodynamic drag.

15. The VAWT system of claim 14, wherein said fairings are configured to be free to rotate about one or more of said blade spacers, blade cables, or said tip cables and, optionally, said fairings may include a flat tail to ensure said fairings are self-aligning to the relative air flow.

16. The VAWT system of claim 2, further comprising a circular ballast ring wherein said ballast ring is attached to said buoyancy torus 4 using vertical ballast cables.

17. The VAWT system of claim 16, wherein the length of said vertical ballast cables is configured to be adjustable wherein an adjustment of said vertical ballast cables is configured to provide a pendulum-swaying motion of said ballast ring so as to act as a Tuned Mass Damper.

18. The VAWT system of claim 16, further comprising ballast cross cables wherein a connection of the ballast ring to the buoyancy torus is at least substantially rigid.

19. The VAWT system of claim 18, wherein said ballast cross cables are configured to be pre-tensioned so that they remain in tension during most wave and wind loading events.

20. The VAWT system of claim 2, further comprising a center ballast that is attached to the buoyancy torus 4 using angled ballast cables and where the connections to said center ballast allow said angled ballast cables to remain in tension during most wave and wind loading events incurred by said system.

21. The VAWT system of claim 2, wherein:
said buoyancy torus has an external ring torus shape or is composed of a series of eight or more cylindrical sections to approximate a ring torus shape;
said buoyancy torus is thin-walled to contain air inside and is water-tight and semi-submerged to provide buoyancy as a floating wind turbine platform; and
said buoyancy torus is inhibited from rotating during power generation by mooring lines.

22. The VAWT system of claim 1, further comprising one or more rotation ring rails that are fixed to said rotation ring so the that said rotation ring rails rotate about the same axis of rotation and at the same RPM as that of said rotation ring.

23. The VAWT system of claim 22, further comprising:
wheels;
wherein said buoyancy torus is configured to support one or more electrical generators that are configured to extract rotational mechanical power from said circular rotor; and
wherein said wheels are located below respective said rotation ring rails and configured to support the vertical load of said circular rotor and where the rotation of said rotation ring rails causes said wheels to rotate and where one or more of these said wheels are used to drive one or more of said electrical generators.

24. A ring-based floating system, wherein said system comprises:
an oil/gas platform which is above a wave zone;
a buoyancy torus, wherein said buoyancy torus include an external ring torus shape or a series of eight or more cylindrical sections to approximate a ring torus shape and wherein said buoyancy torus is thin-walled to contain air inside and is water-tight and semi-submerged to provide buoyancy;
outer columns or trusses which attach and provide vertical support between the platform above and the buoyancy torus below; and
mooring lines that are attached to said buoyancy torus, which serve to help anchor and stabilize said platform.

25. The system of claim 24, further comprising a central column which is partially submerged to provide further buoyancy to support the platform, and wherein horizontal or nearly-horizontal cables are configured to attach the buoyancy torus to said central column to provide additional structural integrity.

26. The system of claim 24, further comprising a circular ballast ring that is attached to said buoyancy torus using vertical ballast cables and wherein said ballast ring hangs below said buoyancy torus.

27. The system of claim 24, further comprising:
a monopile, jacket, or truss configured to be fixed to a bottom wherein said monopile, jacket, or truss configured to provide vertical support to said platform; and
buoyancy cables wherein said buoyancy cables are attached to said monopile, jacket, or truss at a lower depth configured to fully submerge said buoyancy torus.
